(19) United States
(12) Patent Application Publication
(10) Pub. No.: US 2010/0315532 A1
(43) Pub. Date: Dec. 16, 2010

(54) Apparatus for recording and reproducing plural types of information, method and recording medium for controlling same

(75) Inventors: Satoshi Ejima, Tokyo (JP); Akihiko Hamamura, Chiba-shi (JP); Akira Ohmura, Kawasaki-shi (JP)

Correspondence Address: OLIFF & BERRIDGE, PLC, P.O. BOX 320850, ALEXANDRIA, VA, 22320-4850, US

(73) Assignee: Nikon Corporation, Tokyo (JP)

(21) Appl. No.: 12/805,729

(22) Filed: Aug. 17, 2010

Related U.S. Application Data
(63) Continuation of application No. 11/987,972, filed on Dec. 6, 2007, now abandoned.
Application No. 11/987,972 is a continuation of application No. 10/336,002, filed on Jan. 3, 2003, now abandoned.
Application No. 10/336,002 is a continuation of application No. 08/968,162, filed on Nov. 12, 1997, now abandoned.

(30) Foreign Application Priority Data
Jun. 20, 1997 (JP) 09-163899

(51) Int. Cl. H04N 5/76

(52) U.S. Cl. 348/231.99; 348/E05.001

(57) ABSTRACT

Various processes effectively execute updating of related information that is correlated to user selected information. For example, when a selected screen is touched by a pen or the like while an image corresponding to the selected image data is displayed on the screen, existing line drawing data (for example, a first character string) that is correlated to the image data and stored is displayed on the screen. In this instance, if new line drawing data (for example, a second character string) is input using the pen or the like, the new line drawing data is added to the existing line drawing data, and is correlated to the image data being displayed and stored. Different sound data can be correlated to selected image data. Different memo data also can be correlated user selected sound data.

### INCORPORATION BY REFERENCE

This is a Continuation of application Ser. No. 11/987,972 filed Dec. 6, 2007 which is a Continuation of application Ser. No. 10/336,002 filed Jan. 3, 2003, which in turn is a Continuation of application Ser. No. 08/968,162 filed Nov. 12, 1997, which claims priority to Japanese Patent Application No. 09-163899, filed Jun. 20, 1997. The disclosures of the prior applications are hereby incorporated by reference herein in their entirety.

### BACKGROUND OF THE INVENTION

1. Field of Invention

The present invention relates to an information recording and reproduction apparatus, method and recording medium for controlling same in which, for example, new data may be added to existing data by correlating the new data to the existing data.

2. Description of Related Art

In recent years, the use of electronic cameras that shoot an image (a still or moving image) of an object using a CCD and the like, and that record the image in an internal memory or removable memory card and the like after converting the image into digital data have become common in place of cameras that use film. An image photographed with such an electronic camera may be reproduced immediately and displayed on the screen of an LCD and the like without going through the process of development and printing required by a conventional camera.

Moreover, it is also possible that not only images but also different types of information such as line drawings and sound may be recorded. It is also possible that more than one type of information such as still images, line drawings and sound are recorded on separate files and that these types of information are made to be reproduced by being superimposed with each other.

However, it is not certain how to deal with a situation in which a person attempts to input and correlate a line drawing to a still image that is displayed on a screen when that still image already has a line drawing correlated to it (but that may or may not be displayed on the screen when the new line drawing is input).

### SUMMARY OF THE INVENTION

Considering the problem described above, the present invention aims to determine beforehand how to deal with existing information and to avoid the inadvertent overwriting or deletion of the existing information when new information is recorded in the case when more than one type of information is to be recorded by mutual correlation to a particular piece of information (e.g., a still image).

An information recording and reproduction apparatus according to one aspect of the invention includes an input means (for example, a CCD, a touch tablet, and/or a microphone) for inputting more than one type of information. A memory (for example, a removable memory card) stores the information input by the input means. A reproduction means (for example, a CPU) reproduces the information stored in the memory. An updating means (for example, the CPU updates and stores the information in the memory. A controller (for example the CPU) controls the reproduction means to reproduce a third piece of information and the updating means to update the third piece of information with a second piece of information when a first piece of information stored in the memory is reproduced by the reproduction means and a second piece of information that is of a different type the piece of information is input by the input means, and when the third piece of information is of the same type as the second piece of information and is already correlated to the first piece of information and stored in the memory.

The updating means can append the second piece of information to the third piece of information.

Alternatively, the updating means can replace the third piece of information with the second piece of information.

An information recording and reproduction apparatus according to another aspect of the invention includes an input means (for example, a CCD, a touch tablet and/or a microphone) for inputting more than one type of information. An appending means (for example, the CPU) adds identification information to the information input by the input means in order to identify the information. A memory (for example, a removable memory card) stores the information to which the identification information is added. A reproduction means (for example, the CPU) reproduces the information stored in the memory. A controller (for example, the CPU controls the appending means to add appending information to a first piece of stored information, a second piece of information and a third piece of information indicating that the first piece of information, the second piece of information and the third piece of information have the same identification information or mutually correlated information, when the first piece of stored in the memory is reproduced by the reproduction means and the second piece of information of a different type the first piece of information is input by the input means, and the third piece of information is of the same type as the second piece of information and is already correlated to the first piece of information and stored in the memory.

An information recording and reproduction apparatus according to another aspect of the invention includes an input means (for example, a CCD, a touch tablet and/or a microphone) for inputting more than one type of information. An appending means (for example, the CPU) adds identification information to the information input by the input means in order to identify the information. A memory (for example, a removable memory card) stores the information to which the identification information is added. A reproduction means (for example, the CPU) reproduces the information stored in the memory. A controller (for example, the CPU) controls the appending means to add appending information to a first piece of information and to a second piece of information, independent of appending information that indicates correlation between the first piece of information and a third piece of information, indicating that the first piece of information and the second piece of information are mutually correlated,—when the third piece of information that is stored in the memory is reproduced by the reproduction means and the second piece of information is of a different type the first piece of information and is input by the input means when the piece of information is of the same type as the second piece of information and is already to the first piece of information and stored in the memory.

Additionally, the control means can control the reproduction means to reproduce the third piece of information when the first piece of information that is stored in the memory is reproduced by the reproduction means and the second piece of information is input by the input means, when the third piece of information that is of the same type as the second piece of information is already correlated to the first piece of information and stored in the memory.

A prohibition means (for example, the CPU) may also be provided for prohibiting the updating process by the updating means.

The first piece of information can be image data, whereas the second piece of information and the third piece of information can be line drawing data.

The first piece of information can be image data, whereas the second piece of information and the third piece of information can be sound data.

The first piece of can be sound data, whereas the second piece of information and the third piece of information can be line drawing data.

A display (for example, an LCD) can also be provided for displaying the information reproduced by the reproduction means, wherein the reproduction means causes the second piece of information and the third piece of information to be displayed on the display with different concentration.

The control means can control the reproduction means not to reproduce the third piece of information and the updating means to update the third piece of information with the second piece of information when the first piece of information stored in the memory is reproduced by the reproduction means the second piece of information that is of a different type from the piece of information is input by the input means, when the third piece of that is of the same type as the second of information is already correlated to the first piece of information and stored in the memory.

The identification information can be a time that the information was input by the input means.

A recording medium having a computer-readable control program recorded thereon can be provided for use by the to control the apparatus to function as above.

### BRIEF DESCRIPTION OF THE DRAWINGS

The invention will be described in conjunction with the following drawings in which like reference numerals designate like elements and wherein:

FIG. 1 is a perspective view, from the front side of an embodiment of an electronic camera to which the present invention is applied;

FIG. 2 is a perspective view, from the rear side, of the electronic camera with the LCD cover open;

FIG. 3 a perspective view, from the rear side, of the electronic camera with the LCD cover closed;

FIG. 4 shows one example of the internal structure of the electronic camera;

FIGS. 5A-5C are side views of the electronic camera, showing operation of the LCD switch and the LCD cover;

FIG. 6 is a block diagram of an example of the electrical internal structure of the electronic camera;

FIG. 7 illustrates a first thinning process;

FIG. 8 illustrates a second thinning process;

FIG. 9 is an example of a display screen displayed on the LCD of the electronic camera;

FIG. 10 is a flow chart describing a process of reproducing image data and inputting line drawing data correlated to the image data;

FIG. 11 is a display screen illustrating image data and existing line drawing data correlated to the image data;

FIG. 12 is a display screen illustrating reproduction of only image data;

FIG. 13 is a display screen illustrating touching the touch tablet using a pen;

FIG. 14 is a display screen illustrating reproduction and display of existing line drawing data corresponding to the image displayed;

FIG. 15 is a display screen illustrating inputting new line drawing data;

FIG. 16 is a display screen illustrating inputting new line drawing data as a separate file;

FIG. 17 is a display screen illustrating an example of a table display;

FIG. 18 is a display screen illustrating another example of a table display;

FIG. 19 is a display screen illustrating yet another example of a table display;

FIG. 20 is a flow chart describing a process of reproducing sound data and inputting line drawing data correlated to the sound data;

FIG. 21 is a display screen illustrating the existing line drawing data, which is correlated to the sound screen to be displayed when sound data is reproduced, being overlaid and displayed thereon;

FIG. 22 is a display screen illustrating an example of a sound screen to be displayed when only the sound data is reproduced;

FIG. 23 is a display screen illustrating touching the touch tablet using the pen;

FIG. 24 is a display screen illustrating reproduction and displaying of the corresponding existing line drawing data or immediately after reproduction of sound;

FIG. 25 is a display screen illustrating inputting new line drawing data;

FIG. 26 is a display screen illustrating inputting new line drawing data as a separate file;

FIG. 27 is a flow chart describing a process of inputting sound which is correlated to the image data being reproduced;

FIG. 28 is a display screen illustrating an example of a table screen when the newly input sound is correlated to the predetermined image independent of the existing sound; and

FIG. 29 is a display screen illustrating another example of a table screen when the newly input sound is correlated to the predetermined image independent of the existing sound.

### DESCRIPTION OF PREFERRED EMBODIMENTS An embodiment of the present invention is described hereafter, with reference to the drawings.

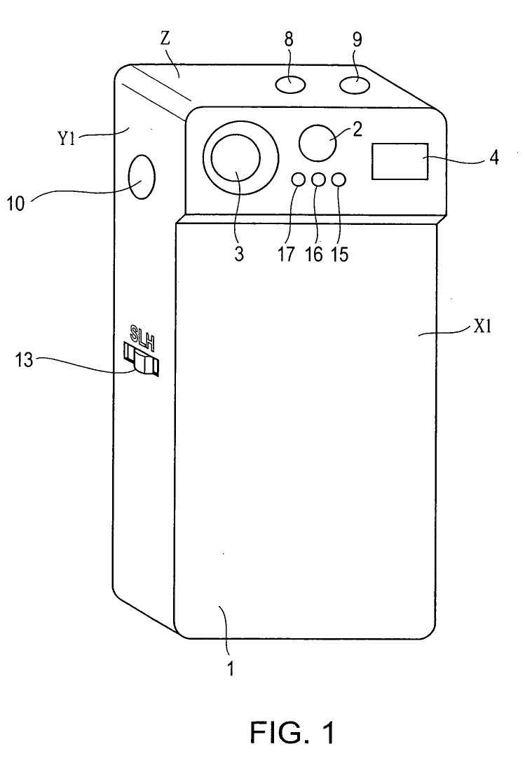

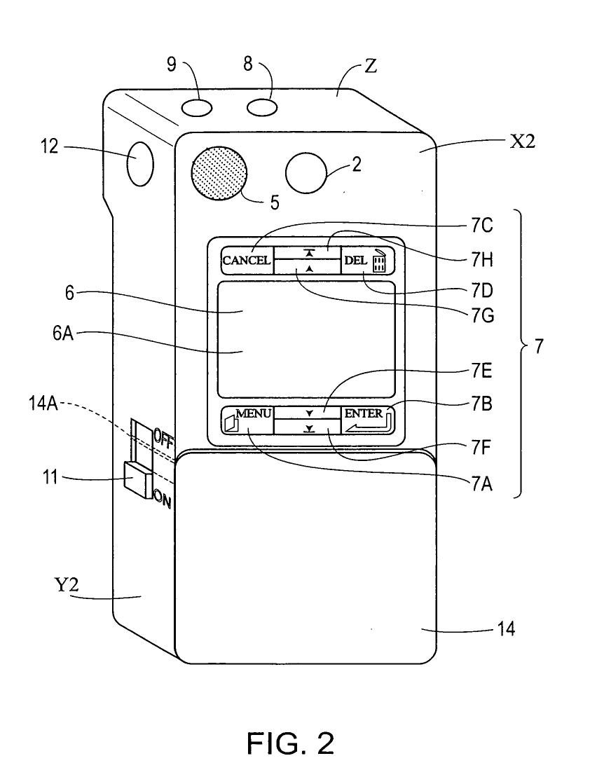

FIG. 1 and FIG. 2 are perspective views describing structural examples of one configuration of an embodiment of an electronic camera 1 to which the present invention is applied. In the electronic camera of the embodiment of the present invention, the surface facing the object is defined as the surface X1 and the surface facing the user is defined as the surface X2 when the object is photographed. On the top edge section of the surface X1 are provided a viewfinder 2 that is used to verify the shooting range of the object, a shooting lens 3 that takes in the optical (light) image of the object, and a light emitting unit (strobe) 4 that emits light to illuminate the object.

Also provided on the surface X1 are a photometry device 16 that measures light during the time when the red-eye reducing (RER) LED 15 is operated to reduce red eye by emitting light before causing the strobe 4 to emit light. A colorimetry device 17 also measures color temperature during this time. A CCD 20 is stopped from photographing during operation of the photometry device 16 and the colorimetry device 17.

On the top edge section of the surface X2 which faces opposite the surface X1 are provided the viewfinder 2 and a speaker 5 that outputs the sound recorded in the electronic camera 1. An LCD 6 and keys 7 are formed on the surface X2 vertically below the viewfinder 2, the shooting lens 3, the light emitting unit 4 and the speaker 5. On the surface of the LCD 6, a so called touch tablet 6A is arranged that outputs position data corresponding to the position designated by the touching operation of pen type pointing device, which will be explained later.

The touch tablet 6A is made of transparent material such as glass or resin. Thus, the user can view an image displayed on the LCD 6, which is formed beneath the touch tablet 6A through the touch tablet 6A.

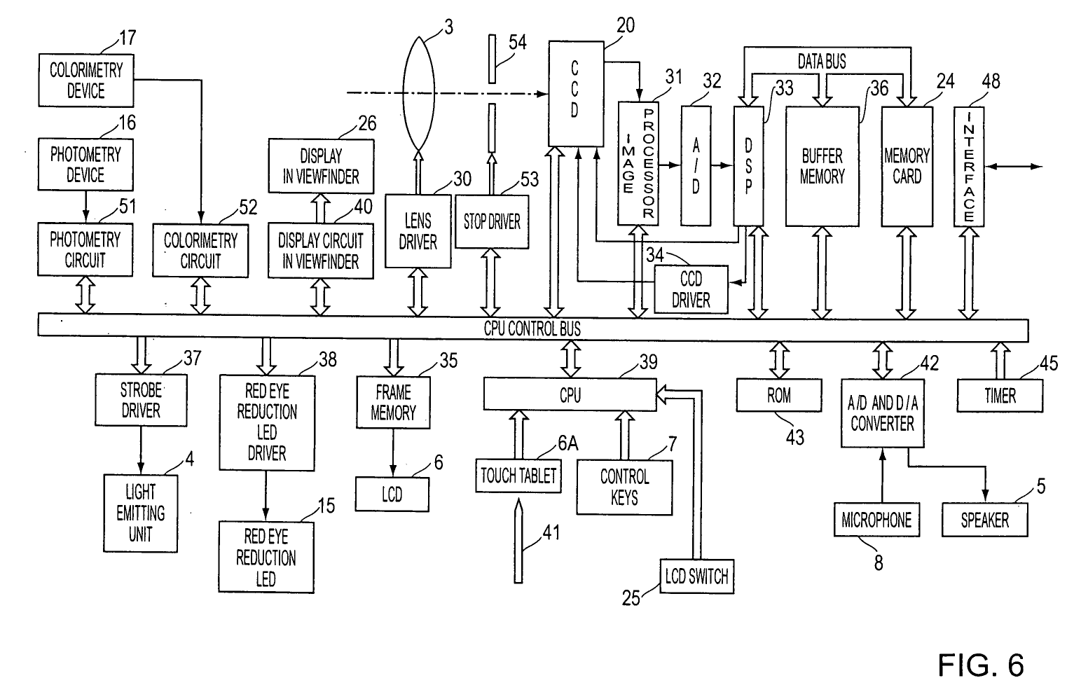

The control keys 7 are operated in reproducing and displaying the recording data on the LCD 6, and detect the operation (input) by the user and supply the user's input to the CPU (central processing unit) 39 (FIG. 6).

The menu key 7A is the key to be operated in displaying the menu screen on the LCD 6. An execution key 7B is the key to be operated in reproducing the recorded information selected by the user. A cancel key 7C is the key to be operated in the reproduction process of recorded information. A delete key 7D is the key to be operated in deleting the recorded information. Scroll keys 7E, 7F, 7G and 7H are operated in scrolling the screen vertically when the recorded information is displayed on the LCD 6 as a table.

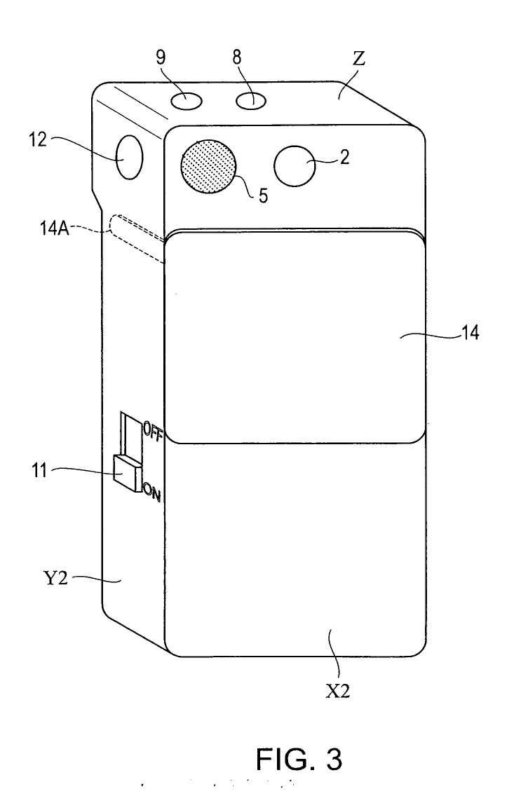

An LCD cover 14 which slides freely is provided on the surface X2 to protect the LCD 6 when it is not in use. When moved upward in the vertical direction, the LCD cover 14 is made to cover the LCD 6 and the touch tablet 6A as shown in FIG. 3. When the LCD cover is moved downward in the vertical direction, the LCD 6 and the touch tablet 6A are exposed, and the power switch 11 (to be mentioned later), which is arranged on the surface Y2, is switched to the on-position by the arm member 14A of the LCD cover 14.

A microphone 8 to gather sound and an earphone jack 9 to which an unillustrated earphone is connected are provided on the surface Z1 which is the top surface of the electronic camera 1.

A release switch 10, which is operated in shooting an object, and a continuous shooting mode switch 13, which is operated in switching the continuous shooting mode during shooting, are provided on the left side surface (surface Y1). The release switch 10 and the continuous shooting mode switch 13 are arranged vertically below the viewfinder 2, the shooting lens 3 and the light emitting unit 4, which are provided on the top edge section of the surface XI.

A recording switch 12, to be operated in recording sound, and a power switch 11 are provided on the surface Y2 (right surface) facing opposite the surface Y 1. Like the release switch 10 and the continuous shooting mode switch 13 described above, the recording switch 12 and the power switch 11 are arranged vertically below the viewfinder 2, the shooting lens 3 and the light emitting 4 which are provided in the top edge section of the surface XI. The recording switch 12 and the release switch of the surface Y1 can be formed virtually at the same height so that the user does not feel a difference when the camera is held either by the right hand or the left hand. Alternatively, the height of the recording switch 12 and the release switch 10 may be different so that the user does not accidentally press the switch provided on the opposite side surface when the other is pressed while the user's fingers hold the other side to offset the moment created by the pressing of the switch.

The continuous shooting mode switch 13 is used when the user decides to shoot one frame or several of the frames of the object when shooting the object by pressing the release switch 10. For example, if the indicator of the continuous shooting mode switch 13 is pointed to the position printed “S” (in other words, when the switch is changed to the S mode), and the release switch 10 is pressed, the camera is made to shoot only one frame. If the indicator of the continuous shooting mode switch 13 is pointed to the position printed “L” (in other words, when the switch is changed to the L mode), and the release switch 10 is pressed, the camera is made to shoot eight frames per second as long as the release switch 10 is pressed (namely, the low speed continuous shooting mode is enabled). If the indicator of the continuous shooting mode switch 13 is pointed to the position printed “H” (in other words, when the switch is changed to the H mode), and the release switch 10 is pressed, the camera is made to shoot 30 frames per second as long as the release switch 10 is pressed (namely, the high speed continuous shooting mode is enabled).

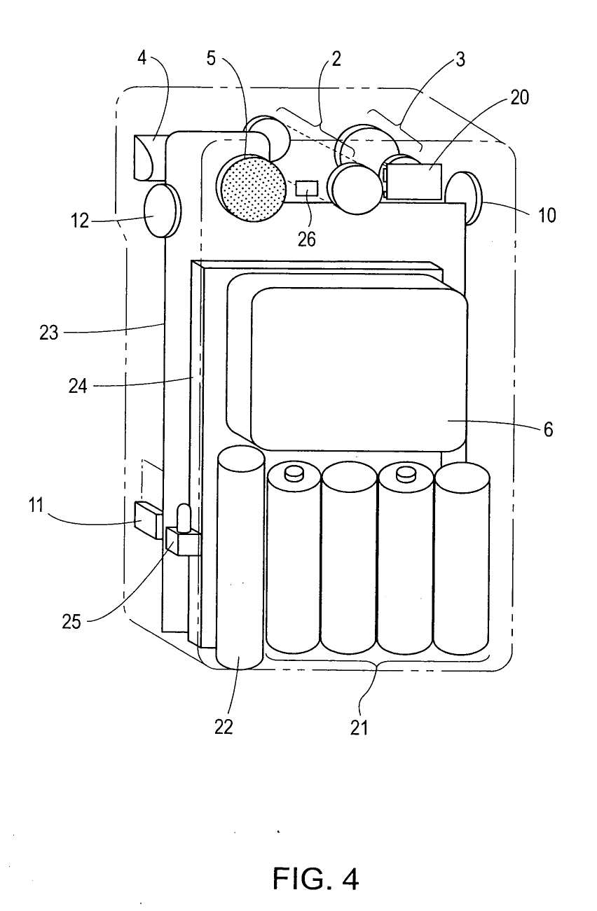

Next, the internal structure of the electronic camera 1 will be described. FIG. 4 is a perspective view showing an example of an internal structure of the electronic camera shown in FIG. 1 and FIG. 2. The CCD 20 is provided near the surface X2 side the shooting lens 3. The optical (light) image of the object imaged through the shooting lens 3 is photoelectrically converted to an electric (image) signal by the CCD 20.

A display device 26 is arranged inside the vision screen of the viewfinder 2 and displays the setting conditions and the like of the various functions for the user who views the object through the viewfinder 2.

Four cylindrical batteries (for example, Advisory Action dry cell batteries) 21 are placed side by side vertically below the LCD 6. The electric power stored in the batteries 21 is supplied to each part of the camera. A capacitor 22 is provided below the LCD 6 and next to the batteries 21 to accumulate electric charge used to cause the light emitting unit 4 to emit light.

Various control circuits are on a circuit board 23 to control each part of the electronic camera 1. A removable memory card 24 is provided between the circuit board 23, the LCD 6 and the batteries 21 so that various information to be input in the electronic camera 1 are recorded in preassigned areas of the memory card 24.

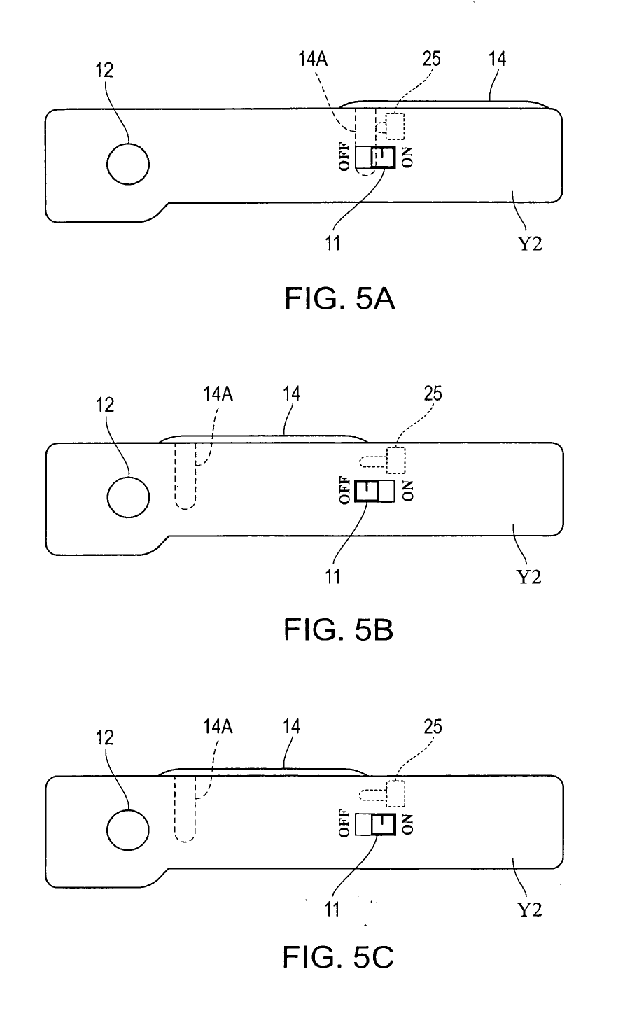

An LCD switch 25, which is arranged adjacent to the power source switch 11, is a switch that turns on when its plunger is pressed and is switched to the ON-state along with the power switch 11 by the arm member 14A of the LCD cover 14 when the LCD cover 14 is moved vertically downward as shown in FIG. 5A.

If the LCD cover 14 moves upward vertically, the power switch 11 can be operated by the user independent of the LCD switch 25. For example, if the LCD cover 14 is closed and the electronic camera 1 is not used, the power switch 11 and the LCD switch 25 are in the off-state as shown in FIG. 5B. In this state, if the user switches the power switch 11 to the on-state, as shown in FIG. 5C, the power switch 11 is placed in the on-state, but the LCD switch 25 continues to be in the off-state. On the other hand, when the power switch 11 and the LCD switch 25 are in the off-state as shown in FIG. 5B, and if the LCD cover 14 is opened, the power switch 11 and 20 the LCD switch 25 are placed in the on-state in FIG. 5A. Then when the LCD cover 14 is closed, only the LCD switch 25 is placed in the off-state as shown in FIG. 5C.

While in the configuration of the present embodiment, the memory card 24 is removable, a memory on which various information can be recorded may be provided on the circuit board 23. Moreover, various information recorded on the memory (memory card 24) may be output to an external personal computer and the like through an interface 48.

An internal electric structure of the electronic camera 1 of the configuration of the present embodiment is described hereafter with reference to the block diagram of FIG. 6. The CCD 20, which includes a plurality of pixels, photoelectrically converts the optical image focused on each pixel into an image signal (electric signal). The digital processor (hereafter referred to as DSP) 33 (which functions as a reproduction means), in addition to supplying the CCD horizontal driving pulse to the CCD 20, supplies the CCD vertical driving pulse to the CCD 20 by controlling the CCD driver 34.

The image processor 3 is controlled by the CPU 39, to sample the image signal photoelectrically converted by the CCD 20 with predetermined timing, and to amplify the sampled signal to a predetermined level. The CPU 39 controls each unit based on one or more control programs stored in ROM (read only memory) 43. The analog/digital conversion circuit (hereafter referred to as the A/C converter) 32 digitizes the image signal sampled by the image processor 31 and supplies it to the DSP 33.

The DSP 33 controls the buffer memory 36 and the data bus to temporarily store the image data supplied the A/D converter 32 in the buffer memory 36, read the image data stored in the buffer memory 36, and record the image data in the memory card 24.

The DSP 33 has the frame memory 35 store image data which is supplied by the A/D converter 32, display the image data on the LCD 6, read the shooting image data from the memory card 24, decompress the shooting image data, then store the decompressed image data in the frame memory 35, and display the decompressed image data on the LCD 6.

The DSP 33 also operates the CCD 20 repeatedly to adjust the exposure time (exposure value) until the exposure level of CCD 20 reaches an appropriate level at the time of starting the electronic camera 1. At such time, the DSP 33 may operate the photometry circuit 51 first, then compute an initial value of the exposure time of CCD 20 corresponding to a light level detected by the photometry device 16. By doing this, adjustment of exposure time for CCD 20 may be achieved in a short time.

In addition, the DSP 33 executes timing management for data input/output during recording on the memory card 24 and the storing of decompressed image data on the buffer memory 36.

The buffer memory 36 is used to accommodate the difference between the data input/output speed for the memory card 24 and the processing speed at the CPU 39 and the DSP 33.

The microphone 8 inputs sound information (gathers sound) and supplies the sound information to the A/D and D/A converter 42.

The A/D and D/A converter 42 converts the analog signal to a digital signal, then supplies the digital signal to the CPU 39. Converter 42 also changes the sound data supplied by the CPU 39 to an analog signal, and outputs the sound signal which has been changed to an analog signal to the speaker 5.

The photometry device 16 measures the light amount of the object and its surrounding area and outputs the measurement results to the photometry circuit 51. The photometry circuit 51 executes a predetermined process on the analog signal which comprises the measurement results supplied the photometry device 16, then converts it to a digital signal, and outputs the digital signal to the CPU 39.

The colorimetry device 17 measures the color temperature of the object and its surrounding area and outputs the measurement results to the colorimetry circuit 52. The colorimetry circuit 52 executes a predetermined process on the analog signal which comprises the color measurement results supplied the photometry device 17, then converts it to a digital signal, and outputs the digital signal to the CPU 39.

The timer 45 has an internal clock circuit and outputs the data corresponding to the current time (date and time) to the CPU 39.

The stop driver 53 sets the diameter of the aperture stop 54 to a predetermined value. The stop 54 is between the shooting lens 3 and CCD 20 and changes the aperture for the light entering from the shooting lens 3 to the CCD 20.

The CPU 39 stops the operation of the photometry circuit 51 and the circuit 52 when the LCD cover 14 is open, the operation of the photometry circuit 51 and the colorimetry circuit 52 when the LCD cover 14 is closed, and stops the operation of the CCD 20 (electronic shutter operation, for example) until the release switch 10 is placed in the half-depressed state.

The CPU 39 receives the light measurement results of the photometry device 16, and receives the color measurement results of the colorimetry device 17 by controlling the photometry circuit 51 and the colorimetry circuit 52 when the operation of the CCD 20 is stopped. The CPU 39 computes a white balance adjustment value corresponding to the color temperature supplied from the colorimetry circuit 52 using a predetermined table, and supplies the white balance value to the image processor 31.

In other words, when the LCD cover 14 is closed, the LCD 6 is not used as an electronic viewfinder, and hence the operation of the CCD 20 stops. The CCD 20 consumes large amounts of electric power, hence by stopping the operation of the CCD 20 as described above, the power of the batteries 21 may be conserved.

Additionally, when the LCD cover 14 is closed, the image processor 31 is controlled in such a manner that the image processor 31 does not execute various processes until the release switch is operated (until the release switch is placed in the half-depressed state).

When the LCD cover 14 is closed, the stop driver 53 is controlled in such a manner that the stop driver 53 does not execute operations such as the changing of the diameter of the aperture stop 54 until the release switch 10 is operated (until the release switch is placed in the half-depressed state).

The CPU 39 also causes the strobe 4 to emit light, at the user's discretion, by controlling the strobe driver 37, and causes the red eye reduction LED 15 to emit light, at the user's discretion, prior to causing the strobe 4 to emit light by controlling the red eye reduction LED driver 38.

In this instance, the CPU 39 cause the strobe 4 not to emit light when the LCD cover 14 is open (in other words, when the electronic viewfinder is used). By doing this, the object may be shot as an image displayed in the electronic viewfinder.

The CPU 39 records information concerning the date of shooting as header information of the image data in a shooting image recording area of the memory card 24 according to the date data supplied the timer 45. (In other words, data of shooting date is attached to the shooting image data to be recorded in the shooting image recording area of the memory card 24.)

Additionally, the CPU 39 temporarily records the digitized and compressed sound data after compressing the digitized sound information to the buffer memory 36, and then records it in a predetermined area (sound recording area) of the memory card 24. The data concerning recording date is recorded simultaneously in the sound recording area of the memory card 24 as header information of the sound data.

The CPU 39 executes an auto focus operation by controlling the lens driver 30 and by moving the shooting lens 3.

The CPU 39 also displays settings and the like for various operations on the display device 26 inside the viewfinder 2 by controlling the display circuit 40 inside the viewfinder.

The CPU 39 exchanges predetermined data with a predetermined external apparatus (for example, a personal computer) through an interface (I/F) 48.

The CPU 39 also receives signals from the control keys 7 and processes them appropriately.

When a position on the touch tablet 6A is pressed by the pen (the pen type pointing member) 41, which is operated by the user, the CPU 39 reads the X-Y coordinates of the position being pressed on the touch tablet 6A and accumulates the coordinate data (memo information to be explained later) in the buffer memory 36. The CPU 39 records the memo information accumulated in the buffer memory 36 in a memo information recording area of the memory card 24 together with header information consisting of the memo information input date.

Next, various operations of the electronic camera 1 of the present embodiment will be explained. Initially, the operation of the electronic viewfinder in the LCD 6 of the present apparatus will be described.

When the user half-depresses the release switch 10, the DSP 33 determines, based on the value of the signal corresponding to the state of the LCD switch 25 which is supplied the CPU 39, whether or not the LCD cover is open. If the LCD cover 14 is determined to be closed the operation of the electronic viewfinder is not executed. In this case, the DSP 33 stops the process until the release switch 10 is operated.

If the LCD cover 14 is closed, the operation of the electronic viewfinder is not executed, and hence, the CPU 39 stops the operation of the CCD 20, the image processor 31 and the stop driver 53. The CPU 39 also makes the photometry circuit 51 and the colorimetry circuit 52 operate and supplies the measurement results to the image processor 31. The image processor 31 uses the values of these measurement results to control white balance and the value of brightness. When the release switch 10 is operated, the CPU 39 causes the CCD 20 and the stop driver 53 to operate.

On the other hand, if the LCD cover 14 is open, the CCD 20 executes the electronic shutter operation with a predetermined exposure time for each predetermined time interval, executes the photoelectric conversion of the photo image of the object gathered by the shooting lens 3, and outputs the resulting image signal to the image processor 31. The image processor 31 controls white balance and brightness value, executes a predetermined process on the image signal, and then outputs the image signal to the converter 32. In this instance, if the CCD 20 is operating, the image processor 31 uses an adjusted value computed based on the output from the CCD 20 by the CPU 39 and which is used for controlling the white balance and the brightness value.

Furthermore, the A/D converter 32 converts the image signal (analog signal) into image data (a digital signal), and outputs the image data to the DSP 33. The DSP 33 outputs the image data to the frame memory 35 and causes the LCD 6 to display the image corresponding to the image data.

In this manner, in the electronic camera 1, the CCD 20 operates the electronic shutter at predetermined time intervals when the LCD cover 14 is open, and executes the operation of the electronic viewfinder by converting the signal output from the CCD 20 into image data each time, outputting the image data to the frame memory 35 and continuously displays the image of the object on the LCD 6.

When the LCD cover 14 is closed as described above, the electronic viewfinder operation is not executed and operation of CCD 20, the image processor 31 and the stop driver 53 are halted to conserve energy.

Next, shooting of the object using the present apparatus will be described.

First of all, a case in which the continuous shooting mode switch 13 provided on the surface Y1 is switched to the S-mode (the mode in which only one frame is shot) will be explained. Initially, power is introduced to the camera 1 by switching the power switch 11 to the “ON” side. The shooting process of the object begins when the release switch 10 provided on the surface Y1 is pressed after the object with the viewfinder 2.

Here, if the LCD cover 14 is closed, the CPU 39 starts the operation of the 2 CCD 20, the image processor 31 and the stop driver 53 when the release switch 10 is in the half-depressed state, and begins the shooting process of the object when the release switch 10 is placed in the fully-depressed state.

The photo image of the object being observed through the viewfinder 2 is gathered by the shooting lens 3 and forms an image on the CCD 20, which has a plurality of pixels. The photo image imaged on the CCD 20 is photoelectrically converted into an image signal by each pixel, and is sampled by the image processor 31. The image signal sampled by the image processor 31 is supplied to the A/D converter 32 where it is digitized, and output to the DSP 33.

The DSP 33, after outputting the image temporarily to the buffer memory 36, reads the image data from the buffer memory 36, compresses the image data using the JPEG (Joint Photographic Experts Group) method, which is a combination of a discrete cosine transformation, quantization, and Huffman encoding, and records the image data in the shooting image recording area of the memory card 24. At this time, the shooting date data is recorded as header information of the shooting image data in the shooting image recording area.

In this instance, if the continuous shooting mode switch 13 is switched to the S-mode, only one frame is shot and further shooting does not take place even if the release switch 10 is continued to be pressed. When the release switch 10 is continuously pressed, the image which has been shot is displayed on the LCD 6 when the LCD cover 14 is open.

Next, a case in which the continuous shooting mode switch 13 is switched to the L-mode (a mode in which 8 frames per second are shot continuously) will be explained. Power is introduced to the electronic camera 1 by switching the power switch 11 to the “ON” side. The shooting process of the object begins when the release switch 10 provided on the surface Y1 is pressed.

In this instance, if the LCD cover 14 is closed, the CPU 39 starts the operation of the CCD 20, the image processor 31 and the stop driver 53 when the release switch 20 10 is in the half-depressed state, and begins the shooting process of the object when the release switch 10 is in the fully-depressed state.

The photo image of the object being observed through the viewfinder 2 is gathered by the shooting lens 3 and forms an image on the CCD 20. The photo image which is imaged on the CCD 20 is photoelectrically converted into an image signal by each pixel, and is sampled by the image processor 31 at a rate of 8 times per second. Additionally, the image processor 31 thins out three-fourths of the pixels of the image signal of all of the pixels in the CCD20.

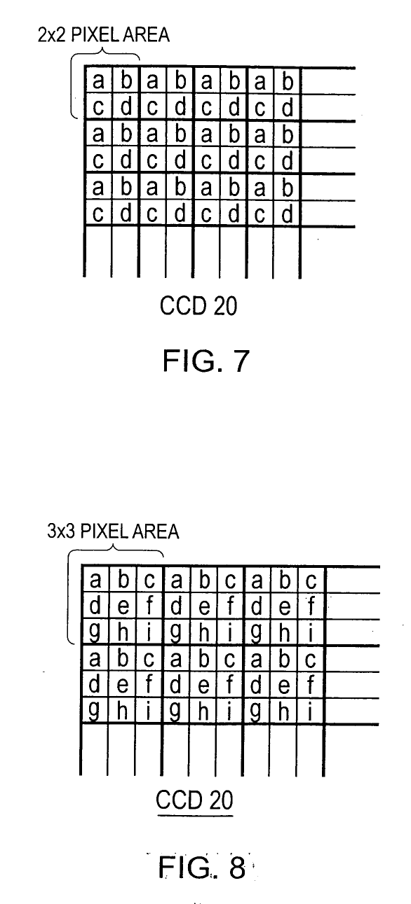

In other words, the image processor 31 divides the pixels in the CCD 20 into areas composed of 2×2 pixels (4 pixels) as shown in FIG. 7, and samples the image signal of one pixel arranged at a predetermined location from each area, thinning out (ignoring) the remaining 3 pixels.

For example, during the first sampling (first frame) pixel a located on the upper corner is sampled and the other pixels b, c and d are thinned out. During the second sampling (second frame), the pixel b located on the right upper corner is sampled and the other pixels a, c and d are thinned out. Likewise, during the third and the fourth samplings, the pixels c and d respectively located at the lower left corner and the right lower corner are sampled and the rest are thinned out. In short, each pixel is sampled once during four samplings.

The image signal (image signal of one-fourth of all the pixels in CCD 20) sampled by the image processor 31 is supplied to the A/D converter 32 where it is digitized and output to the DSP 33.

The DSP 33, after outputting the image temporarily to the buffer memory 36, reads the image data from the buffer memory 36, compresses the image data using the JPEG method, and records the digitized and compressed shooting image data in the shooting image recording area of the memory card 24. At this time, the shooting date data is recorded as header information of the shooting image data in the shooting image recording area.

Third, the case in which the continuous shooting mode switch 13 is switched to the H-mode (a mode in which frames are shot per second) is described. Power is introduced to the electronic camera 1 by switching the power switch 11 to the “ON” side. The shooting process of the object begins when the release switch 10 provided on the surface Y1 is pressed.

In instance, if the LCD cover 14 is closed, the CPU 39 starts the operation of the CCD 20, the image processor 31 and the stop driver 53 when the release switch 10 is in the half-depressed state, and begins the shooting process of the object when the release switch 10 is in the fully-depressed state.

The optical image of the object observed the viewfinder 2 is gathered by the shooting lens 3 and is imaged on the CCD 20. The optical image of the object imaged on the CCD 20 is photoelectrically converted to an image signal by each pixel and is sampled 30 times per second by the image processor 31. Additionally, at this time, the image processor 31 thin outs eight-ninths of the pixels of the image signal of all the pixels in CCD 20. In other words, the image processor 31 divides the pixels in CCD 20 into areas comprising 3×3 pixels (9 pixels) as shown in FIG. 8, and samples, 30 times per second, the image signal of one arranged at a predetermined position in each area. The remaining 8 pixels are thinned out.

For example, during the first sampling (first the pixel a located on the left upper corner of each area is sampled and the other pixels b through i are thinned out. During the second sampling (second frame), the pixel b located on the right of a is sampled and the other pixels a and c through i are thinned out. Likewise, during the third, the fourth and subsequent samplings, the pixel c, the pixel d, etc. . . . are sampled, respectively, and the rest are thinned out. In short, each pixel is once for every nine frames.

The image signal (image signal of one-ninth of all the pixels in CCD 20) sampled by the image processor 31 is supplied to the A/D converter 32 where it is digitized and output to the DSP 33. The DSP 33, after outputting the digitized image signal temporarily to the buffer memory 36, reads the image signal, compresses the image signal using the JPEG method, and records the digitized and compressed shooting image data in the shooting image recording area of the memory card 24.

In this instance, light may be shined on the object, if necessary, by operating the strobe 4. However, when the LCD cover 14 is open, or when the LCD 6 executes the electronic viewfinder operation, the CPU 39 may control the strobe 4 so as not to emit light.

The operation in which two dimensional information (pen input information) is input from the touch tablet 6A will be described next.

When the touch tablet 6A is pressed (contacted) by the tip of the pen 41, the X-Y coordinate of the contact point is supplied to the CPU 39, and the X-Y coordinate is stored in the buffer memory 36. Additionally, the CPU 39 writes data to the address in the frame memory 35 that corresponds to each point of the X-Y coordinate, and a memo corresponding to the contact point of the pen 41 is displayed at the X-Yamamoto coordinate in the LCD 6.

As described above, as the touch tablet 6A is made of transparent material, the user is able to view the point (the point of the location being pressed by the tip of the pen 41) displayed on the LCD 6. This gives the impression that the input is made by the pen directly onto the LCD 6. When the pen 41 is moved on the touch tablet 6A, a line tracing the motion of the pen 41 is displayed on the LCD 6. If the pen 41 is moved intermittently on the touch tablet 5A, a dotted line tracing the motion of the pen 41 is displayed on the LCD 6. In this manner, the user is able to input memo information of desired letters, drawings and the like to the touch tablet 6A (for display on the LCD 6).

When the memo information is input by the pen 41 when a shooting image is already displayed on the LCD 6, the memo information is synthesized (combined) with the shooting image information by the frame memory 35 and displayed together on the LCD 6. Additionally, by operating a predetermined color menu, the user is able to choose the color of the memo to be displayed on the LCD 6 black, white, red, blue and others.

If the execution key 7B is pressed after the memo information is input to the touch tablet 6A by the pen 41, the memo information accumulated in the buffer memory 36 is supplied with header information of the input date to the memory card 24 and is recorded in the memo information area of the memory card 24.

Preferably, the memo recorded in the memory card 24 is compressed information. The memo information input in the touch tablet 6A contains information with a high spatial component. Hence, if the aforementioned JPEG method is used to compress the memo information, the compression efficiency becomes poor and the information amount is not reduced, resulting in a longer time for compression and decompression. Additionally, compression by the JPEG method is lossey compression, and hence is not suitable for the compression of memo information having a small amount of information. (This is because gather and smear due to missing information becomes noticeable when the information is decompressed and displayed on the LCD 6.)

Hence, in the present embodiment, memo information is made to be compressed using the run length method which is used in facsimile machines and the like. The run length method is a method in which the display screen is scanned in the horizontal direction and the memo information is compressed by encoding each continuous length of information (points) of each color such as black, white, red and blue as well as each continuous length of non-information (where there is no pen input). Using the run length method, memo information is compressed to have a minimum amount and the control of missing information becomes possible even when the compressed memo information is decompressed. Additionally, when the amount of memo information is relatively small, it is possible to not compress the memo information.

As mentioned above, if the memo information is input by the pen when the shooting image is already displayed on the LCD 6, the pen input is synthesized with the shooting image information by means of the memory 35 and the synthesized image of the shooting image and the memo is displayed on the LCD 6. On the other hand, the shooting image data is recorded in the shooting image recording area of the memory card 24 and the memo is recorded in the memo information area of the memory card 24. In this manner, two pieces of information are recorded in different areas. Hence, the user can erase one of the two images (the memo, for example) the synthesized images of the shooting image and memo. Further, compression of each piece of image information also is enabled by separate compression methods.

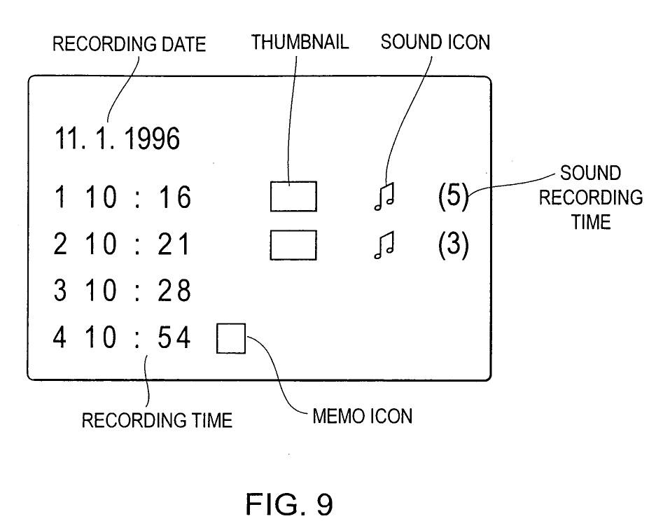

When data is recorded in the sound recording area, the shooting image recording area, or the memo information recording area of the memory card 24, a table containing the data may be displayed on the LCD 6. In the display screen of the 15 LCD 6 shown in FIG. 9, the date of recording information (recording date) (Nov. 1, 1996 in this case) is displayed on the top section of the screen. The number 1, 2, 3, 4, etc.) and the recording time of the information recorded on the recording date are displayed on the left side of the screen.

To the right of the time of recording is displayed a thumbnail image. The thumbnail image is formed by thinning out (reducing) the bit map data of each image data of the shooting image data recorded in the memory card 24. Information entries with this display contain shooting image information. In other words, information recorded (input) at “10:16”, and “10:21” contain shooting image information. Information recorded at the other times do not contain shooting image information.

A memo icon indicates that a memo is recorded as line drawing information for the particular recording time.

A sound icon (a musical note) is displayed on the right of the thumbnail image display area, with the sound recording time (in seconds) being displayed on the right of the sound icon (these are not displayed if sound information is not input).

The user selects (designates) the sound intonation to be reproduced by pressing, with the tip of the pen 41, the desired sound icon in the table displayed on the LCD 6 shown in FIG. 9. The selected information is reproduced by pressing, with the tip of the pen 41, the execution key 7B shown in FIG. 2. For example, if the sound icon at “10:16” shown in FIG. 9 is pressed by the pen 41, the CPU 39 reads the sound data corresponding to the selected sound recording date and time (10:16) from the memory card 24, decompresses the sound data, and then supplies the sound data to the A/D and D/A converter 42. The A/D and D/A converter 42 converts the data to analog signals, and then reproduces the sound through the speaker 5.

In reproducing the shooting image data recorded in the memory card 24, the user selects the by pressing the desired thumbnail image with the tip of the pen 41. The selected information is reproduced by pressing the execution key 7B. In other words, the CPU 39 instructs the DSP 33 to read the shooting image data corresponding to the selected thumbnail image shooting date the memory card 24. The DSP 33 decompresses the shooting image data (compressed shooting data) read the memory card 24 and accumulates the shooting image data as bit map data in the frame memory 35 and displays it on the LCD 6.

The image shot in the S-mode is displayed as a still image on the LCD 6. The still image is obviously the image reproduced from the image signal of all the pixels in the CCD 20.

The image shot in the L-mode is displayed continuously (as a moving picture) at 8 frames per second on the LCD 6. In this case, the number of pixels displayed in each frame is one-fourth of all the in the CCD 20.

Human vision is sensitive to the deterioration of the resolution of the still image. Hence, the user may detect the thinning out of the pixels in the still image. However, the shooting speed is increased in the L-mode where images of 8 are reproduced per second. Thus, although the number of pixels in each frame becomes one-fourth of the number of pixels of the CCD 20, the information amount per unit of time doubles compared to the still image because human eyes observe images of 8 frames per second. In other words, assuming the number of pixels of one frame of the image shot in the S-mode to be one, the number of pixels in one frame of the image shot in the L-mode becomes one-fourth. When the image (still image) shot in the S-mode is displayed on the LCD 6, the amount of information viewed by the human eye per second is 1 (=(number of pixels 1)×(number of frames 1)). On the other hand, when the image shot in the L-mode is displayed on the LCD 6, the amount of information viewed by the human eye per second is 2 (=(number of pixels ¼)×(number of frames 8)). In other words, twice as much amount of information is viewed by the human eye. Hence, even when the number of pixels in one frame is reduced to one-fourth, the user does not notice much deterioration of the image quality during reproduction.

Moreover, in the present embodiment, a different sampling is executed for each frame and the sampled pixels are displayed on the LCD 6. Hence, an after-image effect occurs for the human eye and the user is able to view the image shot in the L-mode and displayed on the LCD 6 without noticing much deterioration of the image, even when three-fourths of the pixels are thinned out per frame.

The image shot in the H-mode is displayed on the LCD 6 for 30 frames per second. At this time, the number of pixels displayed in each is one-ninth of the total number of the pixels of the CCD 20, but the user is able to view the image shot in the H-mode and displayed on the LCD 6 without noticing much deterioration of image quality for the same reasons as in the case of the L-mode.

In the present embodiment, when the object is shot in the L-mode or H-mode, because the image processor 31 thins out the pixels in the CCD 20 in such a manner that the user does not notice much deterioration of the image quality during reproduction, the load on the DSP 33 and the image processor 31 is reduced, enabling the speed and low power operation of these units. Moreover, the low cost low energy consumption operation of the apparatus may be achieved.

In this instance, it is also possible to operate the light emitting unit 4, if necessary, to irradiate light on the object.

As mentioned above, in the present embodiment, data consisting of the date when each information is input is attached, as header information, to various information (data) recorded on the memory card 24. The user is able to select and reproduce the desired information the table screen (FIG. 9) displayed on the LCD 6.

If a plurality of information (shooting image, sound, line drawing) are input simultaneously, each piece of information is recorded separately in its predetermined area of the memory card 24, but in this case, the same date is mutually attached to each information as header information.

For example if information A (shooting image), information B (sound) and information C (line drawing) are input simultaneously, each piece of information A, B and C, which is to be recorded in a predetermined area of the memory card 24, is provided with the data consisting of the same input date as header information. Additionally, it is also permissible to designate the header information of information A to be the data consisting of input date and to designate the header information of information B and information C as data which relate to (i.e., point to) information A.

By using the date data in the manner mentioned above, a plurality of information which are simultaneously input (or otherwise correlated) may be simultaneously reproduced.

In the present embodiment, it is possible to record a second piece of information (for example, line drawing (memo)) which is different the first piece of information shooting (e.g., shooting image data) and which may be appended to the first piece of information after the first piece of information (for example, shooting image) is recorded. In appending the second piece of information to the first piece of information in this manner, the second piece of information is input in a state in which the first piece of information is reproduced. This case is described in detail hereafter.

For example, if the release switch 10 is pressed and the shooting process of the object is executed in a state in which prerecorded sound information is being reproduced, the header information consisting of the date when recording of the sound information is started is attached to the shooting image data to be recorded in the shooting image recording area of the memory card 24.

Additionally, if the shooting process is executed when one has elapsed from the start of reproduction during the reproduction of sound information, the recording of which began at 10:05, Aug. 25, 1995, for example, (i.e., when the reproduction data became the data consisting of 10:06, Aug. 25, 1995), the header information consisting of 10:06, Aug. 25, 1995 may be attached to the shooting image data to be recorded in the shooting image recording area of the memory card 24 (here, the starting time (10:05) may be designated as the header information, or either time may be registered as default data (this selection is left up to the user)).

Likewise, if the line drawing is input when prerecorded sound information is reproduced, the same header information as the header information consisting of the recording date of the sound information is recorded with the line drawing information in the line drawing information recording area of the memory card 24.

If the line drawing information is input while the sound information and the shooting image information that were input simultaneously beforehand are reproduced, the same header information as the header information consisting of the recording date of the sound information (or of the shooting image information) is recorded with the line drawing information in the line drawing information recording area of the memory card 24.

If the shooting image information is input while the sound information and the line drawing information that were input simultaneously beforehand are reproduced, the same header information as the header information consisting of the recording date of the sound information (or the line drawing information) is recorded with the shooting image information in the shooting image information recording area of the memory card 24.

If the sound information is input while the shooting image that was input beforehand is reproduced, the same header information as the header consisting of the recording date of the shooting image is recorded with the sound information in the sound information recording area of the memory card 24.

If the line drawing information is input while the shooting image that was input beforehand is reproduced, the same header information as the header information consisting of the recording date of the shooting image is recorded with the line drawing information in the line drawing information recording area of the memory card 24.

If the sound information is input while the shooting image information and the line drawing information that were input simultaneously beforehand are reproduced, the same header information as the header information consisting of the recording date of the shooting image information (or the line drawing information) is recorded with the sound information in the sound information recording area of the memory card 24.

If the shooting image information is input while the drawing information that was input beforehand is reproduced, the same header information as the header information consisting of the recording date of the line drawing information is recorded with the shooting image data in the shooting image recording area of the memory card 24.

If the sound information is input while the line drawing information that was input beforehand is reproduced, the same header information as the header information consisting of the recording date of the line drawing information is recorded with the sound data in the sound recording area of the memory card 24.

As described above, if a second piece of information is input while a prerecorded first piece of information is being reproduced, the recording date of the first piece of information becomes the header information of the second piece of information (hereafter referred to as a normal mode). In this manner, a relationship between the added information and the existing information is made (i.e., they are correlated) even if the information is added afterwards (i.e., at a later time).

Additionally, in appending the second piece of information to the prerecorded first piece of information in the present embodiment, the input time of the second piece of information may be recorded as the header information of the second piece of information, and in addition, the header of the first piece of information may be rewritten to be the header of the second piece of information (hereafter referred to as the recording date alteration mode). In this case, a recording date mode switch (unrepresented) is further provided in the alteration information input apparatus, enabling the alteration of the recording date (switching between the normal mode and the recording date alteration mode) by the selection of the user.

For example, if the user plans to shoot a specific object at a specific time of a certain later day and records beforehand comments concerning the shooting image as line drawing information (namely, the line drawing information is piece of information), the user may change the mode switch of the recording date above to the recording date alteration mode and shoot the above object while reproducing the prerecorded line information (namely, the shooting image is the second piece of information). By so doing, the input date of the shooting image (the second piece of information) is attached as header information to both the line drawing (the first piece of information) and the shooting image (the second piece of information).

Moreover, a priority order may be assigned to the information input and the header information consisting of input time may be attached to each piece of information. For example, if the priority order of shooting image is the first, the priority order of the sound information becomes the second and the priority order of the line drawing information becomes the third, and if the sound information is input while reproducing a prerecorded line drawing information, the header information containing the input time of the sound information is attached to both the line drawing information and the sound information to be recorded in the memory card 24 (because in this case, the priority order of the sound information is higher than the priority order of the line drawing information). Additionally, if the shooting image is input while the sound information and the line drawing information are reproduced, the header information containing the input time of the shooting image is attached to the line drawing information, the sound information and the shooting image which are recorded in the memory card 24 (because the priority order of the shooting image is higher than the priority order of other information). This priority order may be established by the user.

The case in which sound is recorded while the object is shot will be described next.

First, the case in which the continuous shooting mode switch 13 is switched to the S mode (single shooting mode) is described. Upon pressing the recording switch 12, the sound information is input, and header information including the date when recording is started is recorded with the sound data in the sound information recording area of the memory card 24. Next, if the release switch 10 is pressed while the sound information is input (S mode), the object is shot for one frame, and the shooting image data is recorded in the memory card 24. The header information including the date when the release switch 10 is pressed is attached to the shooting image data.

On the other hand, if the release button 10 is pressed first, the object is shot for one frame. In this case, the shooting date is recorded as header information in the shooting image data to be recorded in the memory card 24. Additionally, if the release button 10 is continuously pressed, the image which was shot is displayed on the LCD 6, and if the recording switch 12 is pressed at this time, the sound information is input. In this case, the shooting date is attached as the header information to the sound data to be recorded in the sound information recording area of the memory card 24.

Next, the case in which the continuous shooting mode switch 13 is switched to the L-mode or the H-mode (continuous shooting mode) is described. If the release switch is pressed first and then the recording switch 12 is pressed, or if the release switch 10 and the recording switch 12 are pressed at the same time, the shooting image and the sound information are recorded as follows.

If the continuous shooting mode switch 13 is switched to the L-mode, eight frames are shot in one second, and the header information including each shooting date is attached to the shooting image data of each frame to be recorded in the shooting image recording area of the memory card 24. Hence, the date with 0.125 second interval is recorded in the header of each frame. Moreover, at this time, the sound information is recorded for each 0.125 second (however, the sound information is input continuously), and the header information consisting of the date at 0.125 second intervals is recorded in the sound data to be recorded in the sound information recording area of the memory card 24.

Similarly, when the continuous shooting mode switch 13 is switched to the H-mode, 30 frames are shot in one second, and the header information including the date of each shooting is attached to the shooting image data of each frame which is to be recorded in the shooting image recording area of the memory card 24. Hence, in this case, the date of 1/30 second intervals is recorded in the header of each frame. In this case, the sound information is recorded at 1/30 second intervals (however the sound information is input continuously), and the header information consisting of date at 1/30 second intervals is recorded for the sound data which is recorded in the sound information recording area of the memory card 24.

By establishing the described arrangement, it becomes possible, when editing the shooting image or sound after recording, to delete an arbitrary shooting image together with the sound information which has the same header information as the header information of the shooting image.

In the meantime, if the continuous shooting mode switch 13 is switched to either the L-mode or the H-mode (if it is switched to the continuous shooting mode), and if the recording switch 12 is pressed first, followed by the pressing of the release switch 10, the header information shown below is recorded in the information to be recorded in the memory card 24.

In other words, in this case, the sound data until the pressing of the release switch 10 is recorded as one file in the sound information recording area of the memory card 24. Then when the release switch 10 is pressed, the header information consisting of the date corresponding to each frame of the shooting image is recorded with the sound data.

Now, in the configuration of the present embodiment, it is possible to record memo (line drawing) as well as to shoot a photographic image of the object. In the configuration of the present embodiment, a mode (the shooting mode and the memo input mode) to input this information is provided, and the mode is appropriately selected by the operation of the user, thus enabling the problem-free execution of information input.

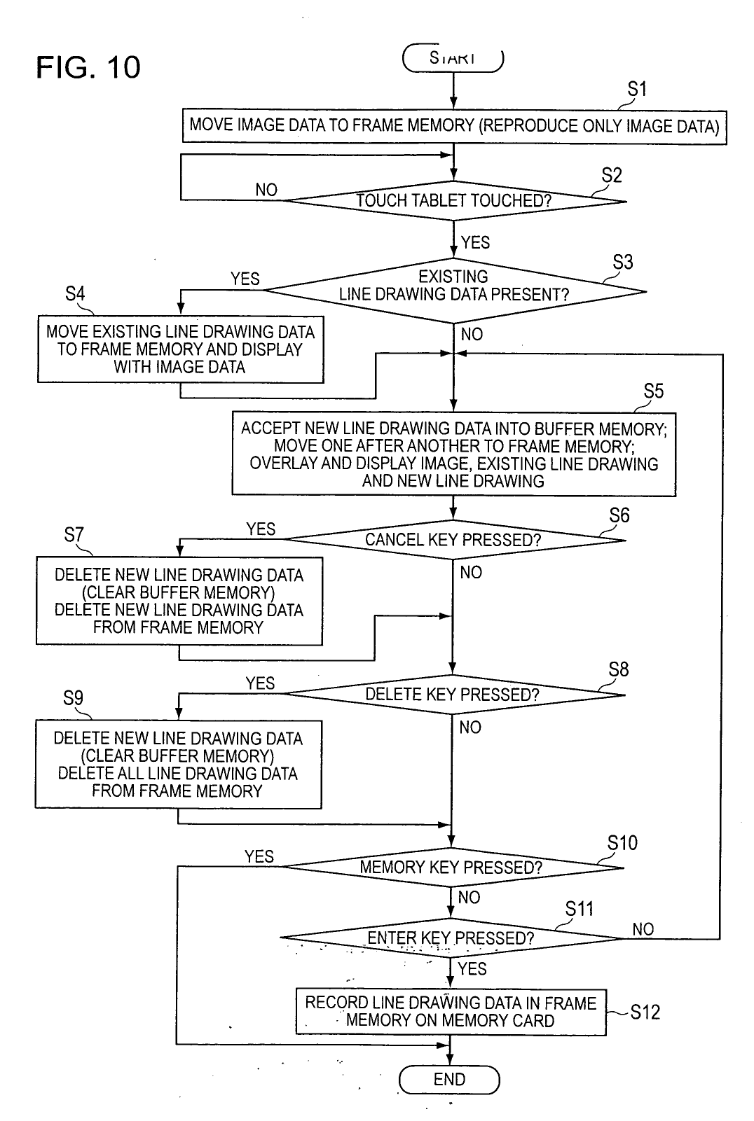

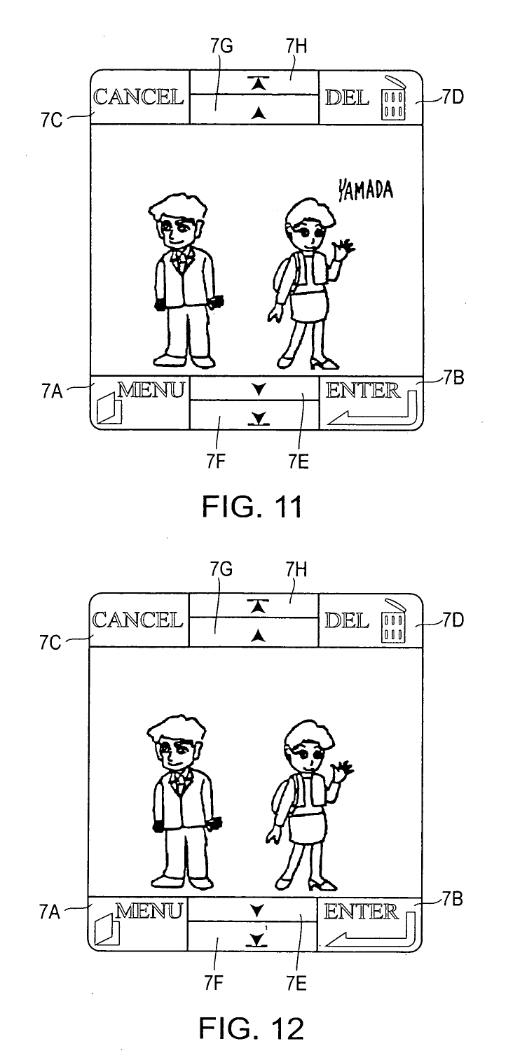

The operation of newly recording the memo data by reproducing only the image data in the state when the memo information (memo data (line drawing data)) is correlated to predetermined image data is described in detail hereafter with reference to the flow chart in FIG. 10. FIG. 11 shows the state in which the above image data and the line drawing data are reproduced.

To begin with, at step S1 the user executes a predetermined operation to display a table screen on the LCD 6 such as the one shown in FIG. 9. Then, the user selects a predetermined thumbnail image using the pen 41 and the like. The information corresponding to the selected thumbnail image is supplied to the CPU 39. Then the CPU 39 reads the image data corresponding the thumbnail image which is selected and stored in the memory card 24, which image data is transferred to the frame memory 35. By so doing, the image corresponding to the selected thumbnail image is displayed on the screen of the LCD 6 as in FIG. 12.

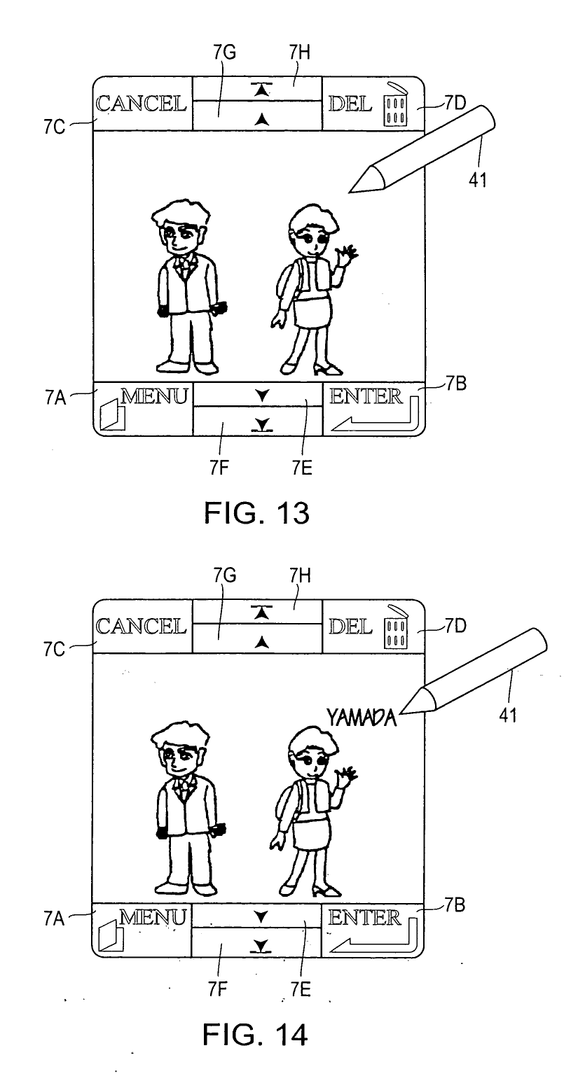

Next, at step S2, the CPU 39 determines whether or not the touch tablet 6A is touched by the pen 41 or the like. If the touch tablet 6A is determined not to have been touched by the pen 41 or the like, the process of step S2 is repeated. On the other hand, if the touch tablet 6A is determined to have been touched by the pen 41 or the like as shown in FIG. 13, the CPU 39 moves to step S3 and determines whether or not existing line drawing data correlated to the image currently displayed on the screen of the LCD 6 and stored in the memory card 24 is present.

If the CPU 39 determines that existing line drawing data correlated to the image currently displayed on the screen of the LCD 6 and stored in the memory card 24 is present, the CPU 39 moves to step S4 where the CPU 39 reads and transfers the existing line drawing data to the frame memory 35. By so doing, the image corresponding to the thumbnail image which is selected previously and the line drawing (in this case “YAMADA”) correlated to the image and stored are displayed overlaid with each other as shown in FIG. 14.

Upon completion of process of step S4 or if during step S3 the CPU 39 determines that existing line drawing data correlated to the image currently displayed on the screen of the LCD 6 is not present, the CPU 39 moves to step S5.

At step s5, line drawing data is newly input by the user through the touch tablet 6A. The line drawing data which is input is temporarily supplied to and stored in the buffer memory 36 through control of the CPU 39. The CPU 39 supplies the line drawing data stored in the buffer memory 36 to the frame memory 35 one after another. Hence, if the existing line drawing is present, the existing line drawing data stored in the frame memory 35.

In this instance, the existing line drawing data and the new line drawing data may be displayed in different colors.

If existing line drawing data is not the newly input new line drawing data is displayed overlaid with the image data on the screen of the LCD 6, as shown in FIG. 16.

Next, at step S6, the CPU 39 determines whether or not the cancel key 7C is pressed. If the cancel key 7C is determined to have been pressed, the CPU 39 moves to step S7 and deletes the new line drawing data stored in the buffer memory 36. Likewise, the new line drawing data stored in the frame memory 35 is deleted.

Upon completion of the process at step S7 or upon determining that the cancel key has not been pressed at step S6, the CPU 39 moves to step S8 and determines whether or not the delete key 7D is pressed. If the delete key 7D is determined to have been pressed, the CPU 39 moves to step 59 and deletes the new line drawing 25 data stored in the buffer memory 36. Additionally, of the line drawing data stored in the memory 35 are deleted. In other words, both the existing line drawing data and the new line data are deleted.

Upon completion of the process at step or upon determining that the delete key has not been pressed at step S8, the CPU 39 moves to step S10.

The CPU 39 determines at step S10 whether or not the menu key 7A is pressed. If the menu key 7A is determined not to have been pressed, the CPU 39 moves to step S11 and determines whether or not the execution key (enter key) 7B is pressed. If the execution key 7B is determined not to have been pressed, the CPU 39 returns to step S5 and repeats the execution of the process at step S5 and thereafter. On the other hand, if the execution key 7B is determined to have been pressed at step S11, the CPU 39 moves to step S12 and supplies and stores all the line drawing data stored in the frame memory 35 in the memory card 24.

In the meantime, if the menu key 7A is determined to have been pressed at step S10, the process is completed. Hence, the data being stored in the memory card 24 is not updated, as a result, the line drawing data is not updated. In other words, the update process may be interrupted by pressing the menu key 7A and the existing line drawing data may be restored.

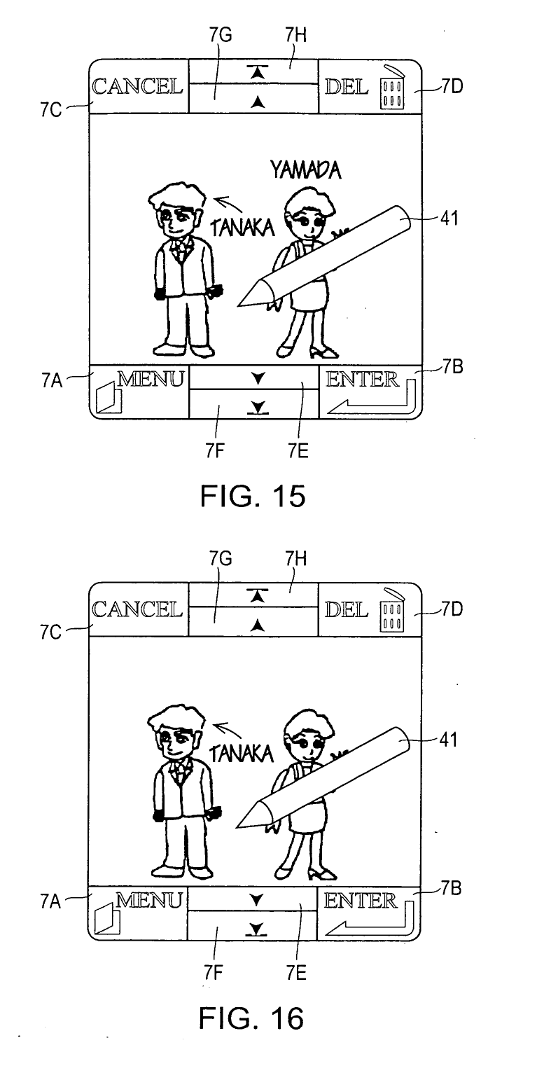

For example, by inputting the new line drawing data at step S5 and by pressing the execution key 7B, information consisting of existing line drawing data and newly added line drawing data may be stored in the memory card 24, as shown in FIG. 15. Additionally, after deleting the line drawing data in the memory 35 by pressing the delete key 7D and inputting the new line drawing data at step S51 then pressing the execution key 7B, the existing line drawing data may be deleted and only the new line drawing data is correlated to the image currently displayed on the screen of the LCD 6 and stored in the memory card 24.

In the case of the above example, the line drawing data is recorded in the memory card 24 as one file, but it is also possible, when the new line drawing data is input, to store the existing line drawing data and the new line drawing data in the memory card 24 as separate files.

As described above, header information including the input date of the image data is attached to the image data. In particular, similar header information is added to the line drawing data correlated to the image data. When the new line drawing data is input in the above state, a method in which the header information consisting of the same input date as the input date of the header information attached to the image data (the image data displayed on the screen of the LCD 6 when the new line drawing data is input) correlated to the new line drawing data is attached to the new line drawing data, or a method in which the header information consisting of the input date when the new drawing data is input is attached to the new line drawing data may be adopted.

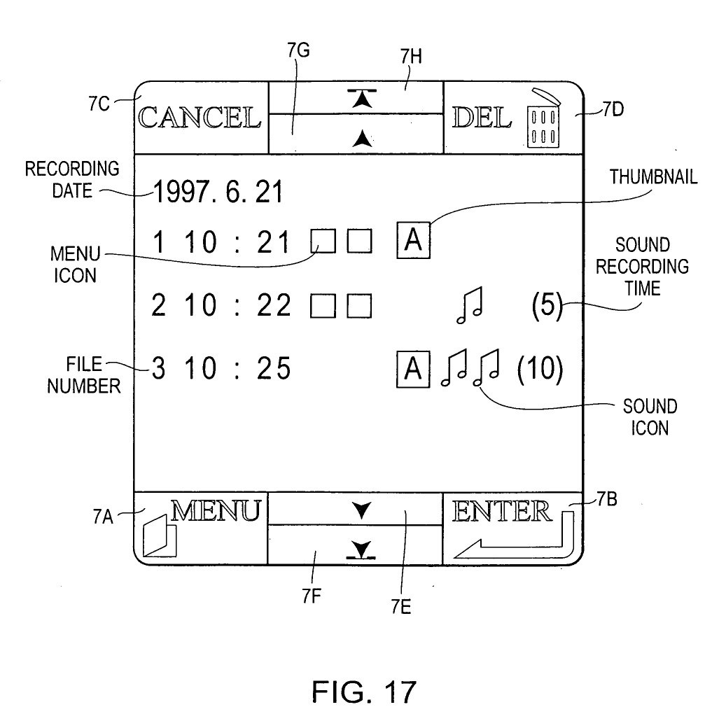

When the header information consisting of the same input date as the input date of the header information attached to the image data correlated to the new line drawing data is attached to the new line drawing data, a table screen such as one shown in FIG. 17 is displayed. In other words, the image data corresponding to the thumbnail image A and two line drawing data (two memos) correlated to the image data are considered to have been input at the same time and two memo icons corresponding to each line drawing data are displayed side-by-side after (to the right in this example) the same recording (10:21 in this example).

Hence, in this case, the thumbnail image A and two line drawing data corresponding to the thumbnail image A may be simultaneously reproduced and the three data may be displayed on the LCD 6 overlaid with each other.

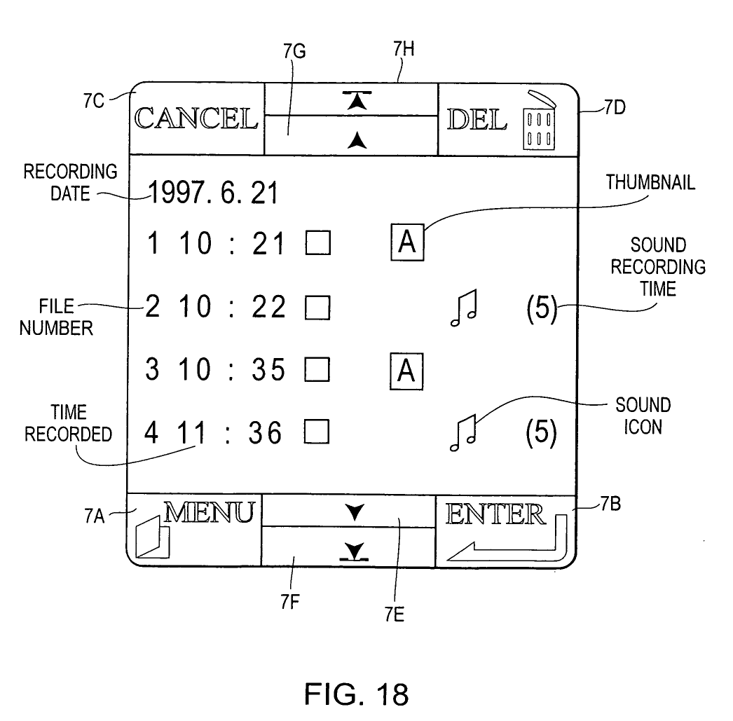

In the meantime, if the header information including the input date when the new line drawing data is input is attached to the new line drawing data, a screen such as the one shown in FIG. 18 is displayed. In other words, the thumbnail image A corresponding to the image data that is input at 10:21 and the memo icon corresponding to the line drawing data correlated to the thumbnail image A are displayed, and the memo icon corresponding to the new line drawing data input at 10:35 is displayed, and the thumbnail image A corresponding to the image which has been displayed on the screen of the LCD 6 at the time of input of the line drawing is displayed after the memo icon.

In other words, in this case, the line drawing data correlated to the image data is input and stored in the memory card 24, for example. Then, the new line drawing data is input at 10:35 while the image data is reproduced and is displayed on the screen of the LCD 6. The existing line drawing data and the new line drawing data are made to correspond, independent of each other, to the predetermined image data corresponding to the thumbnail image A in this manner. Hence, the existing line drawing data and the new line drawing data may be displayed, independent of each other, on the screen of the LCD 6 overlaid with the image data corresponding to the thumbnail image A.

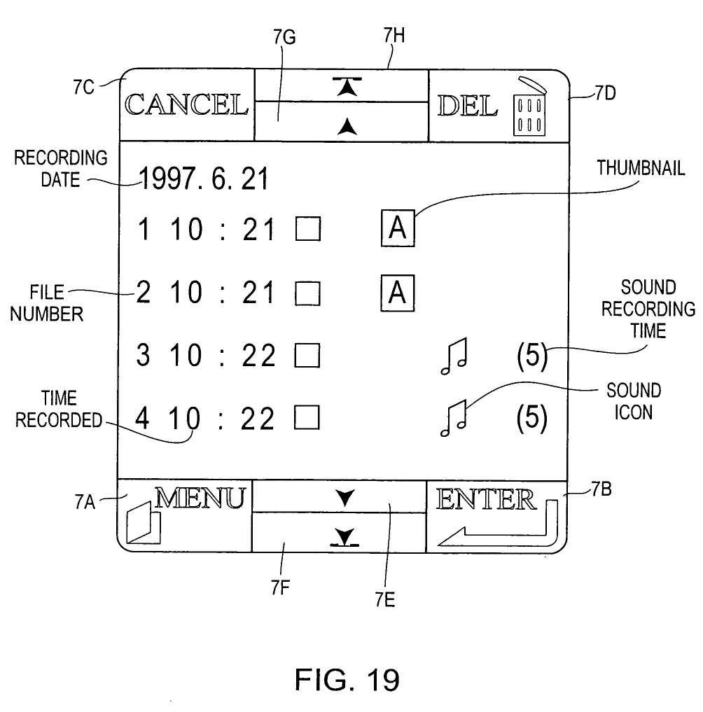

Additionally, as shown in FIG. 19, header information including the input date of the image data corresponding to the thumbnail image A may be attached to the new line drawing data, and the correlation of the image data corresponding to the thumbnail image A and the new line drawing data may be executed independent of correlation of the image data corresponding to the thumbnail image A and the existing line drawing data. In the case of the present example, the thumbnail image A corresponding to the image data input at 10:21 and the memo icon corresponding to the existing line drawing data correlated to the image data corresponding to the thumbnail image A are displayed, and then the thumbnail image A corresponding to the image data input at 10:21 and the memo icon corresponding to the new line drawing data correlated to the image data corresponding to the thumbnail image A are displayed.

Hence, also in this case, the image data corresponding to the thumbnail image A and the existing line drawing data correlated to the image data may be displayed overlaid with each other, or the image data corresponding to the thumbnail A and the new line drawing data correlated to the image data may be displayed overlaid with each other.

By making the existing line drawing data and the new line drawing data separate files in this manner, the occurrence of problems may be avoided in rearranging the data in the table screen by the order of updating. Additionally, if the files are separated, the existing line drawing data may be kept from being displayed on the screen of the LCD 6 at step S4.

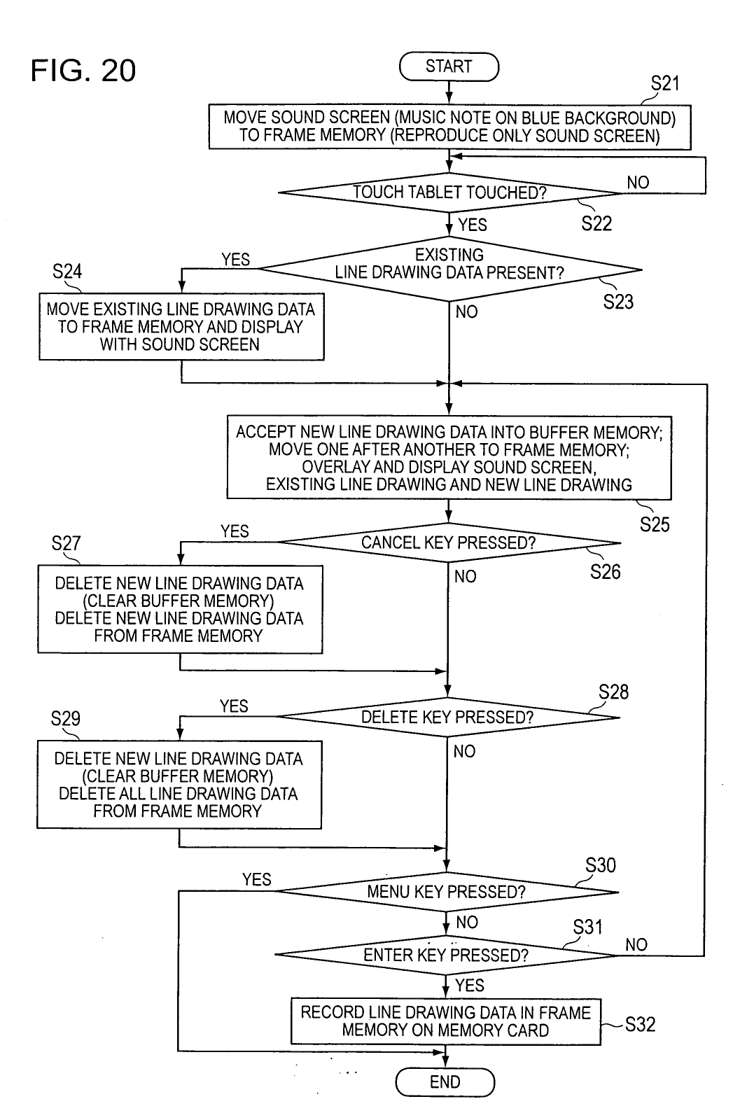

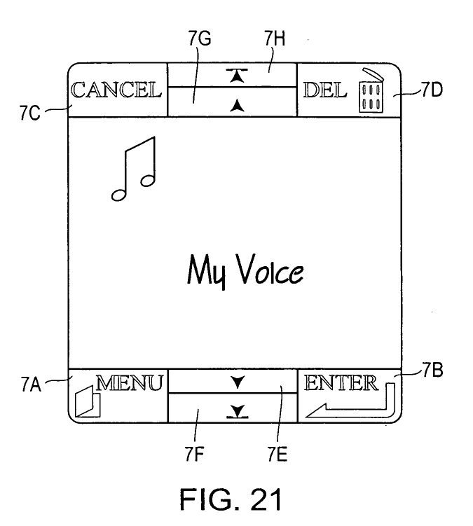

Next, the operation of reproducing only the sound data and recording new memo data while previously recorded memo (memo data (line drawing data)) is correlated to the sound data will be described with reference to the flow chart in FIG. 20. FIG. 21 shows an example of a screen displayed in the LCD 6 when the above sound data and the (previously recorded) line drawing data are reproduced.

First, at step S21, the user executes a predetermined operation to cause a table screen such as the one shown in FIG. 9 to be displayed on the LCD 6. Then the user selects a particular sound icon using the pen 41 or the like. The information corresponding to the selected sound icon is supplied to the CPU 39 and the CPU 39 reads the sound data corresponding to the selected sound icon, which is stored in the memory card 24, and transfers it to the buffer memory 36. The sound data transferred to the buffer memory 36 is supplied to A/D and D/A converter 42 to be converted into analog sound signals, that then are output from the speaker 5.

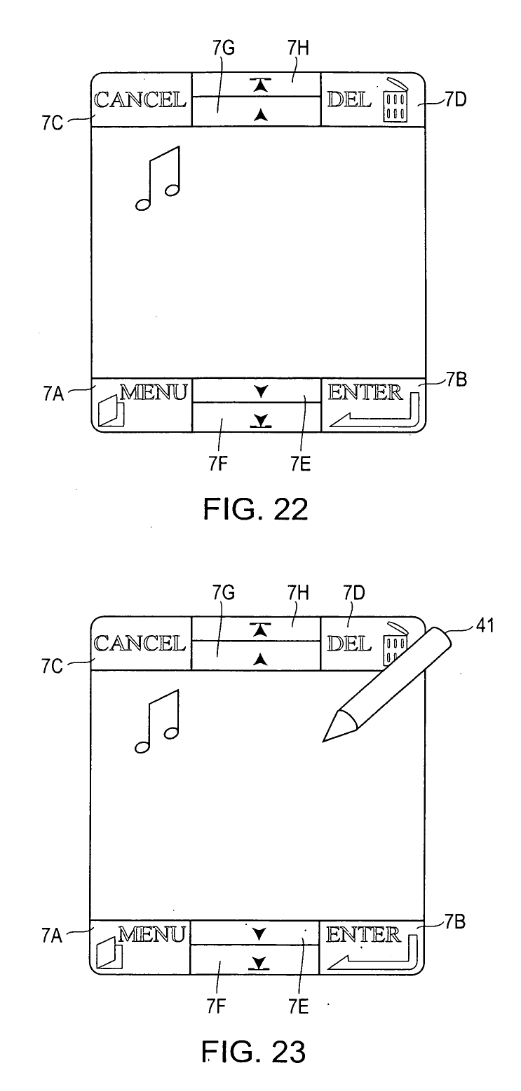

Additionally, the CPU 39 supplies the data for displaying the sound icon to the memory 35. By so doing, a predetermined musical note mark is displayed on the upper left corner of the screen in the LCD 6 indicating the selection of the sound icon as shown in FIG. 22. Hereafter, the screen on which the musical note mark is displayed on the upper left corner will be called the sound screen.

Next, at step S22, the CPU 39 determines whether or not the touch tablet 6A is touched by the pen 41 or the like. If the touch tablet 6A is determined not to have been touched by the pen 41 or the like, the process of step S22 is repeated. On the other hand, if the touch tablet 6A is determined to have been touched by the pen 41 or the like as shown in FIG. 23, the CPU 39 moves to step S23 and determines whether or not existing line drawing data correlated to the sound data currently reproduced and stored in the memory card 24 is present.

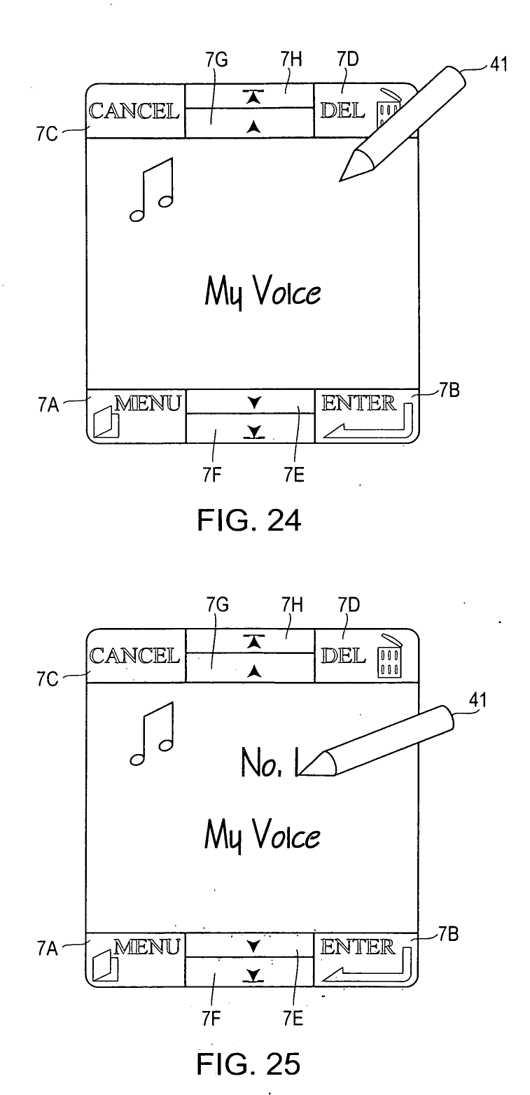

If the CPU 39 determines that existing line drawing data correlated to the sound data reproduced and stored in the memory card 24 is present, the CPU 39 moves to step S24 where the CPU 39 reads and transfers the existing line drawing data to the buffer memory 36. The line drawing data transferred to the buffer memory 36 is supplied to the memory 35. By so doing, the line drawing (in the present example “My Voice”) corresponding to the existing line drawing data correlated to the previously selected sound icon and stored in memory is displayed on the screen of the LCD 6 overlaid with the sound screen as shown in FIG. 24.

Upon completion of the process of step S24 or if during step S23 the CPU 39 determines that existing line drawing data correlated to the sound data currently reproduced is not present, the CPU 39 moves to step S25.

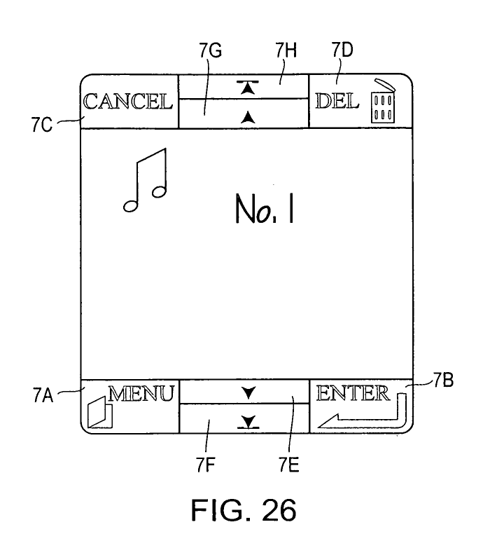

At step S25, line drawing data is newly input by the user through the touch tablet 6A. The drawing data which is input is temporarily supplied to and stored in the buffer memory 36 through control of the CPU 39. The CPU 39 supplies the line drawing data stored in the buffer memory 36 to the memory 35 one after another. Hence, if an existing line drawing is present, the existing line drawing data stored in the frame memory 35 (“My Voice,” in this case) and the newly input line drawing data (“No. 1 in this case) are displayed overlaid with each other on the screen of the LCD 6, as shown in FIG. 25. If existing line drawing data is not present, the new line drawing data currently input is displayed on the screen of the LCD 6 overlaid with the image data as shown in FIG. 26.

Next, at step S26, the CPU 39 determines whether or not the cancel key 7C is pressed. If the cancel key 7C is determined to have been pressed, the CPU 39 moves to step S27 and deletes the new line drawing data stored in the buffer memory 36. Likewise, the new line drawing data stored in the memory 35 is deleted.

Upon completion of the process of step S27 or upon determining that the cancel key 7C has not been pressed at step S26, the CPU 39 moves to step S28 and whether or not the delete key 7D is pressed. If the delete key 7D is determined to have been pressed, the CPU 39 moves to step S29 and deletes the new line drawing data stored in the buffer memory 36. Additionally, of the line drawing data stored in the memory 35 is deleted. In other words, both the existing line drawing data and the new line drawing data are deleted.

Upon completion of the process of step S29 or upon determining that the delete key 7D has not been pressed at step 528, the CPU 39 moves to step S30.

The CPU 39 determines at step S30 whether or not the menu key 7A is pressed. If the menu key 7A is determined not to have been pressed, the CPU 39 moves to step S31 and determines whether or not the execution key (enter key) 7B is pressed. If the execution key 7B is determined not to have been pressed, the CPU 39 returns to step S25 and repeats execution of the processes at step S25 and thereafter. On the other hand, if the execution key 7B is determined to have been pressed at step S31 the CPU 39 moves to step S32 and supplies and stores all the line drawing data stored in the frame memory 35 in the memory card 24.

In the meantime, if the menu key 7A is determined to have been pressed at step 530, the process is completed. Hence, the data being stored in the memory card 24 is not updated, and as a result, the line drawing data is not updated. In other words, the update process may be interrupted by pressing the menu key 7A and the previously existing line drawing data may be restored.

For example, by inputting the new line drawing data at step S25 and by pressing the execution key 7B, consisting of existing line drawing data and newly added line drawing data may be stored in the memory card 24, as shown in FIG. 25. Additionally, after deleting the line drawing data in the memory 35 by pressing the delete key 7D and inputting the new line drawing data at step S25, then by pressing the execution key 7B, the existing line drawing data may be deleted and only the new line drawing data may be correlated to the image currently displayed on the screen of the LCD 6 and stored in the memory card 24.

In the above example, the line drawing data is recorded in the memory card 24 as one file, but it is also possible, when the new line drawing data is input, to store the existing line drawing data and the new drawing data in the memory card 24 as separate files, which will be explained later.

As described above, header including the input date of the sound data is attached to the sound data as described above for the image data. Additionally, similar header information is added to the line drawing data that is correlated to the sound data. When the new line drawing data is input in the above state, a method in which header information including the same input date as the input date of the header information attached to the sound data (the sound data reproduced during or immediately before the new line drawing data is input) that is correlated to the new line drawing data is attached to the new line drawing data, or a method in which header information including the input date when the new line drawing data is input is attached to the new line drawing data may be adopted.

When header information including the same input date as the input date of the header information attached to the sound data correlated to the new drawing data is attached to the new line drawing data, a table screen such as the one shown in FIG. 17 is displayed (see File No. 2). In other words, the sound icon corresponding to a particular sound and two line drawing data that are correlated to the sound icon are considered to have been input at the same time the two memo icons corresponding to each line drawing data are displayed side-by-side after (to the right in this example) the same recording time (10:22 in this example). Hence, in this case, the sound data and two line drawing data corresponding to the sound data may be reproduced simultaneously. The sound corresponding to the sound data may be output from the speaker 5, and the two line drawing data correlated to the sound may be displayed on the LCD 6 overlaid with each other.

In the meantime, if the header information including the input date when the new line drawing data is input is attached to the new line drawing data, a screen such as the one shown in FIG. 18 is displayed. In other words, the sound icon corresponding to the sound data that is input at 10:22 and the memo icon corresponding to the previously existing line drawing data correlated to the sound icon are displayed, and the sound icon corresponding to the sound data reproduced at a particular time, or immediately before when the memo icon corresponding to the new line drawing data is input (at 10:36 and a memo icon are displayed. In other words, in this case, the line drawing data correlated to the sound data is input at 10:22 and stored in the memory card 24, for example. Then, the new line drawing data is input when the sound data is reproduced and output the speaker 5 at 10:36 and separately correlated to each other. The existing line drawing data and the new line drawing data are made to correspond, independent of each other, to the predetermined sound data in this manner, hence, the existing line drawing data and the new line drawing data may be displayed, independently correlated to the sound data, on the screen of the LCD 6.

Additionally, as shown in FIG. 19, header information including the input date when the sound data, which is output from the speaker 5 at the time or immediately before when the new line drawing data is input, may be attached to the new line drawing data, and the of the sound data and the new line drawing data may be executed independent of the correlation of the sound data and the existing line drawing data.

In the case of the present example, the sound icon corresponding to the sound data input at 10:22 and the memo icon corresponding to the existing line drawing data which is correlated to the sound data are displayed, and then the sound icon corresponding to the sound data input at 10:22 and the memo icon corresponding to the new drawing data correlated to the sound icon are displayed.

Hence, also in this case, the sound data and the existing line drawing data correlated to the sound data may be reproduced together, or the sound data and the new line drawing data correlated to the sound data may be reproduced together. Additionally, by making the existing line drawing data and the new line drawing data separate files in this manner, the occurrence of problems may be avoided in rearranging the data in the table screen by the order of updating. If the files are separated, the existing line drawing data may be kept from being displayed on the screen of the LCD 6 at step S24.

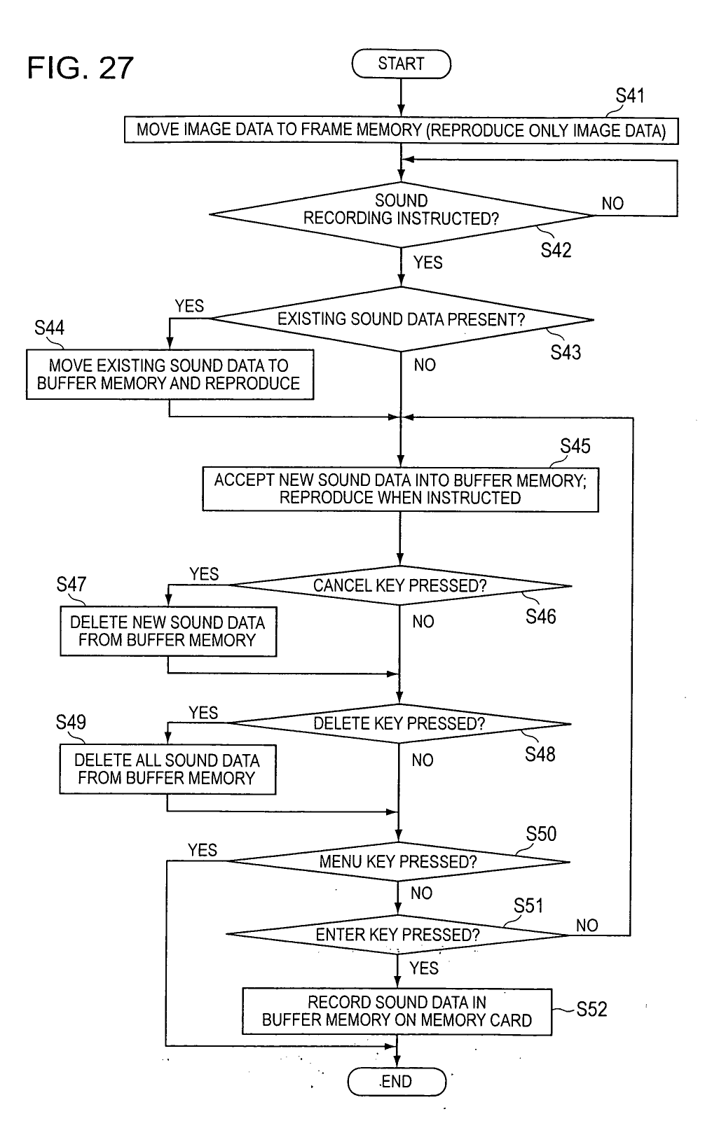

The operation of reproducing only the image data and recording new sound data while previous sound data has been stored correlated to the image data is described hereafter, reference to the flow chart in FIG. 27.

First, at step S41, the user executes a predetermined operation that causes a table screen such as the one shown in FIG. 9 to be on the LCD 6. Then the user selects a particular thumbnail image using the pen 41 or the like. The information corresponding to the selected thumbnail image is supplied to the CPU 39 and the CPU 39 reads the image data corresponding to the selected thumbnail image stored in the memory card 24 and transfers it to the frame memory 35. By so doing, the image corresponding to the selected thumbnail image is displayed on the screen of the LCD 6 as shown in FIG. 11.

Next, at step S42, the CPU 39 determines whether or not the recording switch 12 is operated. If the recording switch 12 is determined not to have been operated, the process of step S42 is repeated. On the other hand, if the recording switch 12 is determined to have been operated, the CPU 39 moves to step S43 and whether or not existing sound data correlated with the image currently displayed on the screen of the LCD 6 and stored in the memory card 24 is present.

If the CPU 39 determines that existing sound data correlated to the image currently displayed on the screen of the LCD 6 and stored in the memory card 24 is present, the CPU 39 moves to step S44 where the CPU 39 reads and transfers the existing sound data to the buffer memory 36. The sound data being transferred to the buffer memory 36 is supplied to A/D and D/A converter 42 to be converted into analog sound signals, which then are output the speaker 5.

Upon completion of the process of step S44 or if during step S43, the CPU 39 determines that existing sound data correlated to the image currently displayed on the screen of the LCD 6 and is not present, the CPU 39 moves to step S45.

At step S45, new sound data is input by the user through the microphone 8. The input sound data is temporarily supplied to and stored in the buffer memory 36 through control of the CPU 39. At this time, by displaying the sound screen such as one shown in FIG. 22 overlaid with the image and by selecting the sound icon which is displayed on the upper left corner of the sound screen, the sound data stored in the buffer memory 36 may be reproduced and output through the speaker 5.

Next, at step S46, the CPU 39 determines whether or not the cancel key 7C is pressed. If the cancel key 7C is determined to have been pressed, the CPU 39 moves to step S47 and deletes the new sound data stored in the buffer memory 36.

Upon completion of the process of step S47 or upon determining that the cancel key 7C has not been pressed at step S46, the CPU 39 moves to step S48 and determines whether or not the delete key 7D is pressed. If the delete key 7D is determined to have been pressed, the CPU 39 moves to step S49 and deletes all the sound data stored in the buffer memory 36. In other words, both the existing sound data and the new sound data are deleted.

Upon completion of the process of step S49 or upon determining that the delete key 7D has not been pressed at step S48, the CPU 39 moves to step S50.

The CPU 39 determines at step S50 whether or not the menu key 7A is pressed. If the menu key 7A is determined not to have been pressed, the CPU 39 moves to step S51 and determines whether or not the execution key (enter key) 7B is pressed. If the execution key 7B is determined not to have been pressed, the CPU 39 10 returns to step S45 and repeats the execution of the processes at step S45 and thereafter. On the other hand, if the execution key 7B is determined to have been pressed at step S51, the CPU 39 moves to step S52 and supplies and stores all the sound data stored in the buffer memory 36 in the memory card 24.

In the meantime, if the menu key 7A is determined to have been pressed at step S50, the process is completed. Hence, the data being stored in the memory card 24 is not updated, and as a result, the sound data is not updated. In other words, the update process may be by pressing the menu key 7A and the existing sound data may be restored.

For example, by inputting the new sound data at step S45 and by pressing the execution key 7B, information consisting of existing sound data and newly added sound data may be stored in the memory card 24. Additionally, after deleting the sound data in the buffer memory 36 by pressing the delete key 7D and inputting the new sound data at step S45, then by pressing the execution key 7B, the existing sound data may be deleted and only the new sound data may be correlated to the image currently displayed on the screen of the LCD 6 and stored in the memory card 24.

In the above example, the sound data is recorded in the memory card 24 as one file, but it is also possible, when the new sound data is input, to store the existing sound data and the new sound data in the memory card 24 as separate files.

As described above, header information including the input date of the image is attached to the image data. Similar header information is added to the sound data correlated to the image. When new sound data is input in the above state, a method in the header information consisting of the same input date as the input date of the header information attached to the image data (the image data displayed at the time when the new sound data is input) which is correlated to the new sound data is attached to the new sound data, or a method in which the header information including the input date when the new sound data is input is attached to the new sound data may be adopted.

When the header information including the same input date as the input date of the header information attached to the image data correlated to the new sound data is attached to the new sound data, a table screen such as the one shown in FIG. 17 is displayed. In other words, the thumbnail image B corresponding to the selected image data and two sound data that are correlated to the thumbnail image are considered to have been input at the same time and the two sound icons corresponding to each sound data are displayed side-by-side after (to the right in this example) the thumbnail image, for example. Hence, in this case, the thumbnail image and two sound data corresponding to the thumbnail image may be simultaneously reproduced, and the image corresponding to the thumbnail image may be displayed on the LCD 6, and the two sound data correlated to the image may be output 5 the speaker 5.

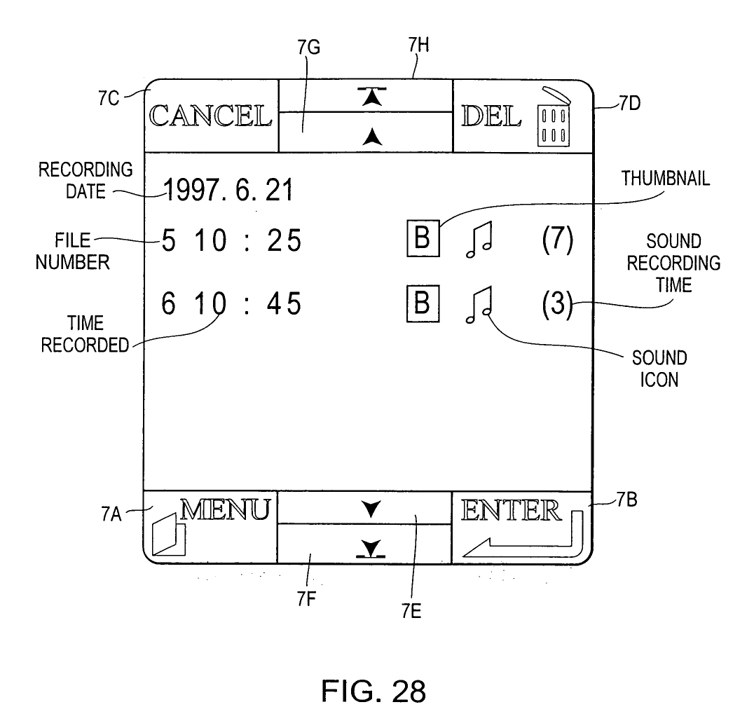

In the meantime, if the header information including the input date when the new sound data is input is attached to the new sound data, a screen such as the one shown in FIG. 28 is displayed. In other words, the thumbnail image B corresponding to the image data input at 10:25 and the sound icon corresponding to the sound data correlated to the thumbnail image are displayed, and the sound icon corresponding to the new sound data input at 10:45 is displayed, and the thumbnail image B corresponding to the image displayed on the screen of the LCD 6 at the time when the new sound data is input is displayed before the sound icon (to the left in the present example). In other words, in this case, the sound data correlated to the image data is input at 10:25 and stored in the memory card 24, for example. Then, the new sound data is input at 10:45 while the image data is reproduced and displayed on the screen of the LCD 6.

The existing sound data and the new sound data correspond, independent of each other, to the selected image data which corresponds to the thumbnail image B in this manner. Hence, the existing sound data and the new sound data may independently correspond to the image corresponding to the thumbnail image, and each sound data may be reproduced and output from the speaker 5 separately.

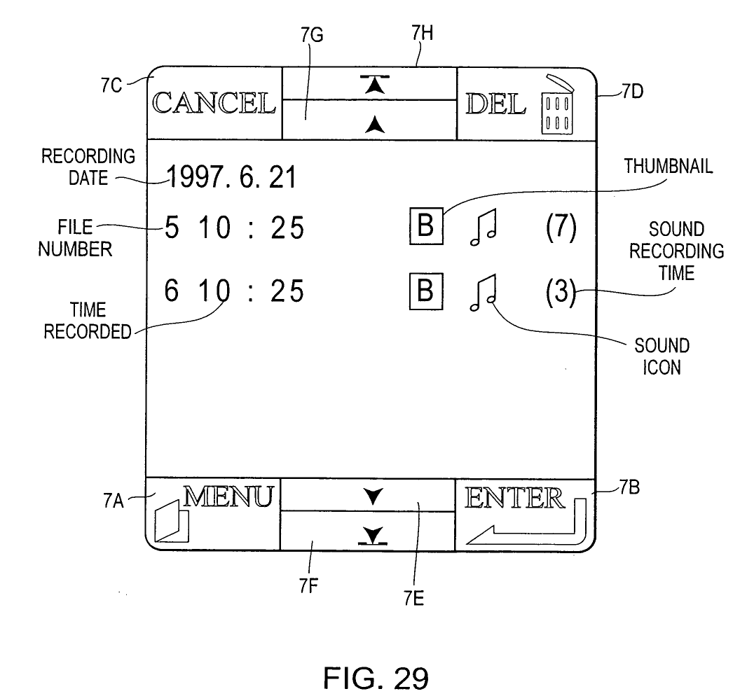

Additionally, as shown in FIG. 29, the header information including the input date when the image data corresponding to the thumbnail image is input may be attached to the new sound data, and the correlation of the image and the new sound data may be executed independent of correlation of the image and the existing sound data. In the case of the present example, the thumbnail image B corresponding to the image data input at 10:25 and the sound icon corresponding to the existing sound data correlated to the image data corresponding to the thumbnail image B are displayed, and then the thumbnail image B corresponding to the image data input at 10:25 and the sound icon corresponding to the new sound data correlated image data corresponding to the thumbnail image B are displayed. Hence, also in this case, the image data corresponding to the thumbnail image B and the existing sound data correlated to the image data may be reproduced together, or the image data corresponding to the thumbnail image B and the new sound data correlated to the image data may be reproduced together.

In the configuration of the above embodiment, a switch for prohibiting update of data may be provided and, if the existing correlated to the predetermined data/data is present, updating of that data may be prohibited.

Additionally, in the configuration of above embodiment, the program that causes the CPU 39 to execute each process of FIGS. 10, 20 and 27 may be stored in the ROM 43 or the memory card 24 of the electronic camera 1. Furthermore, such a program may be supplied by the user stored beforehand in the ROM 43 or the memory card 24, or it may be supplied by the user stored in, e.g., a CD-ROM (compact disk-read only memory) and the like in such a manner that the program may be copied to the ROM 43 or to the memory card 24. In this case, the ROM 43 may be an EEPROM (electrically erasable and programmable read only memory) enabling rewriting electrically. The program also can be provided over a communications network such as, for example, the Internet (World Wide Web).

In the configuration of the above embodiment, the viewfinder 2 is an optical viewfinder but it is also possible to use a liquid crystal viewfinder.

Additionally, in the configuration of the above embodiment, the shooting lens, the viewfinder and the light emitting unit are arranged in the following order from the left relative to the direction of viewing the electronic camera from the but it is also possible to arrange them in the following order from the right.

In the configuration of the above embodiment, only one microphone is provided but it is also possible to provide two microphones, one on the right and the other on the left, to record sound in stereo.

Furthermore, in the configuration of the above embodiment, various information are input using a pen type pointer but it is also possible to provide input using the fingers. Additionally, other selection techniques can be used with the invention. For example a cursor that is movable via a mouse and that makes selections upon clicking of the mouse can be used with the invention.

Moreover, the display screens displayed on the LCD 6 were merely examples, and the present invention is not limited to these examples. It is also possible to use screens with various layouts. Likewise, the type and layout of the control keys are mere examples and the present invention is not limited to these examples.

Additionally, in the configuration of the above embodiment, when new sound data is added to existing sound data and recorded, reproduction of the existing sound data at step S44 in FIG. 27 may be omitted. This is because sometimes input of new sound data becomes impossible once the reproduction of the sound data starts, until completion of the reproduction (for example, for several seconds).

In the configuration of the above embodiment, a case in which the present invention is applied to an electronic camera is described, but the present invention may also be applied to other equipment.

Furthermore, in the configuration of the above embodiment, a case in which still pictures, line drawings and sound are handled, but motion pictures and other information may also be handled.

In the illustrated embodiment, the invention was implemented by programming a general purpose computer (CPU 39). However, the controller of the invention can be implemented as a single special purpose integrated circuit (e.g., ASIC) having a main or central processor section for overall, system-level control, and separate sections dedicated to performing various different specific computations, functions and other processes under control of the central processor section. It will be appreciated by those skilled in the art that the controller can also be implemented using a plurality of separate dedicated or programmable integrated or other electronic circuits or devices (e.g., hardwired electronic or logic circuits such as discrete element circuits, or programmable logic devices such as PLDs, PLAs, PALs or the like). The controller can also be implemented using a suitably programmed general purpose computer, e.g., a microprocessor, microcontroller or other processor device (CPU or MPU), either alone or in conjunction with one or more peripheral (e.g., integrated circuit) data and signal processing devices. In general, any device or assembly of devices on which a finite state machine capable of implementing the flow charts shown in FIGS. 10, 20 and 27 can be used as the controller.

While this invention has been described in conjunction with specific embodiments thereof, it is evident that many alternatives, and variations will be apparent to those skilled in the art. Accordingly, the preferred embodiments of the invention set forth herein are intended to be illustrative, not limiting. Various changes may be made without departing the spirit and scope of the invention as defined in the following claims.

What is claimed is:

1. An information recording and reproduction apparatus comprising:
an input device that inputs plural types of information;
a record control device that records the information input from the input device into a memory;
a reproduction device that connects with the memory and reproduces the information recorded in the memory; and
a control device that controls the input device, the record control device, and the reproduction device,
wherein when a new piece of information input from the input device is correlated to a first piece of information recorded in the memory and reproduced by the reproduction device and the new piece of information is recorded into the memory, the control device determines whether the new piece of information is the same type of information as a second piece of information correlated with the first piece of information and recorded in the memory, if the control device determines that the new piece of information is the same type of information as the second piece of information, the record control device records a third piece of information including the second piece of information and the new piece of information in place of the second piece of information into the memory, the third piece of information being correlated to the first piece of information.

2. An information recording and reproduction apparatus according to claim 1, wherein the first piece of information is image data.

3. An information recording and reproduction apparatus according to claim 2, wherein the second piece of information is sound data.

4. An information recording and reproduction apparatus according to claim 2, wherein the second piece of information is line drawing data.

5. An information recording and reproduction method comprising:
inputting plural types of information;
recording the information input, into a memory; and
connecting with the memory and reproducing the information recorded in the memory;
wherein when a new piece of information input is correlated to a first piece of information that is recorded in the memory and reproduced by the reproduction device and the new piece of information is recorded into the memory, it is determined whether the new piece of information is the same type of information as a second piece of information correlated with the first piece of information and recorded in the memory, if it is determined that the new piece of information is the same type of information as the second piece of information, a third piece of information that includes the second piece of information and the new piece of information is recorded in the memory in place of the second piece of information, the third piece of information being correlated to the first piece of information.

6. A computer readable medium storing a computer program that causes a computer to perform an information recording and reproduction method comprising:
inputting plural types of information;
recording the information input, into a memory; and
connecting with the memory and reproducing the information recorded in the memory;
wherein when a new piece of information input is correlated to a first piece of information that is recorded in the memory and reproduced by the reproduction device and the new piece of information is recorded into the memory, it is determined whether the new piece of information is the same type of information as a second piece of information correlated with the first piece of information and recorded in the memory, if it is determined that the new piece of information is the same type of information as the second piece of information, a third piece of information that includes the second piece of information and the new piece of information is recorded in the memory in place of the second piece of information, the third piece of information being correlated to the first piece of information.
